(19) United States
(12) Patent Application Publication
(10) Pub. No.: US 2024/0260568 A1
(43) Pub. Date: Aug. 8, 2024

(54) THAWING OF CRYOPRESERVED MATERIALS USING AUTOMATIC SINGLE-MODE ELECTROMAGNETIC RESONANCE

(71) Applicant: University of Washington, Seattle, WA (US)

(72) Inventors: Dayong Gao, Seattle, WA (US); Shaohang Hao, Seattle, WA (US); Ye Jin, Seattle, WA (US); Ruidong Ma, Seattle, WA (US); Shen Zen, Seattle, WA (US); Zhiquan Shu, Seattle, WA (US); Ziyuan Wang, Seattle, WA (US); Ming Chen, Seattle, WA (US)

(73) Assignee: University of Washington, Seattle, WA (US)

(21) Appl. No.: 18/565,073

(22) PCT Filed: May 26, 2022
(86) PCT No.: PCT/US2022/031219

§ 371 Date: Nov. 28, 2023

Related U.S. Application Data
(60) Provisional application No. 63/194,401, filed on May 28, 2021.

(51) Int. Cl. A01N 1/02; H05B 6/64; H05B 6/68; H05B 6/80

(52) U.S. Cl. CPC A01N 1/0284; A01N 1/0294; H05B 6/6452; H05B 6/6491; H05B 6/68; H05B 6/688; H05B 6/80

(57) ABSTRACT

An example method for rewarming a cryopreserved material includes identifying a parameter indicating a state of a container enclosing a single-mode electromagnetic field. The method further includes maintaining the single-mode electromagnetic field by adjusting, based on the parameter, a frequency and/or a power of the electromagnetic waves.

### CROSS-REFERENCE TO RELATED APPLICATION(S)

This application claims the priority of U.S. Provisional Application No. 63/194,401, filed on May 28, 2021, and which is incorporated by reference herein in its entirety.

### TECHNICAL FIELD

This application relates to devices, systems, and methods for achieving rapid and uniform warming of materials, such as cryopreserved tissues.

### BACKGROUND

Tissue and organ transplantation remains the most effective treatment for those patients who suffered from acute or chronic organ failures (Bezinover, D et al., BMC Anesthesiology, 19(1):32, 2019; Rall, W et al., Nature, 313, 573-575, 1985). Unfortunately, there is a long waiting list for transplantation due to the lack effective organ preservation methods. A severe organ shortage exists worldwide. Organ transplants offer the best prospective improvement in the health of an individual with a failing or failed organ. A clear reason for the shortage of available organs for transplant is an effective long term storage method.

Current hypothermic storage technologies, for example, could maintain the viability of hearts and lungs for up to 4 hours, intestine, pancreas, and liver for 8 to 12 hours, and kidney for up to 36 hours (Lewis, J. K. et al., Cryobiology, 72(2), 169-182, 2016). However, in such a short period, most of the tissues and organs (>80%) are wasted due to insufficient time to match a recipient or exceeded the maximum storage time during transportation and handling.

Cryopreservation, a technology to preserve the biomaterials at low temperatures to pause the biological and chemical reactions, is a potential solution to long-term tissue and organ preservation. Low temperature for cryopreservation can be achieved using liquid nitrogen, which reduces the temperature of cells, tissue, and organs to −96° Celsius (C). At such low temperatures, biological and chemical reactions are significantly slowed and/or paused, which enables long-term tissue preservation. The challenge then becomes how to bring the tissues/organs from low temperature back to our body temperature.

To date, successful cryopreservation is limited to small volume biomaterials due to, in part, the challenges remaining in the rewarming process (Berendsen, T. A. et al., Nature Medicine, 20, 790-793, 2014). First, a rapid rewarming rate is needed to avoid fatal ice-recrystallization. Second, this rapid rate needs to be homogeneously distributed within the entire sample (to achieve uniform temperature distribution) to prevent thermal-stress-induced fracture. Therefore, a rapid and uniform rewarming technology is needed.

### BRIEF DESCRIPTION OF THE DRAWINGS

Some of the drawings submitted herewith may be better understood in color. Applicant considers the color versions of the drawings as part of the original submission and reserves the right to present color images of the drawings in later proceedings.

FIG. 1 illustrates an example environment for warming a sample.

FIG. 2 illustrates example signaling for warming up a sample using single-mode EM field heating.

FIG. 3 is a diagram illustrating an example of a single mode EM field.

FIG. 4 illustrates a model of a system including the secondary container and the EM wave generator.

FIG. 5 illustrates an example nanoparticle in a fluid used to warm a sample.

FIG. 6 illustrates a block diagram of an example system for achieving single-mode EM wave heating of a sample.

FIG. 7 illustrates an example loading system for EM-based rewarming.

FIG. 8 illustrates an example process for single-mode EM wave heating of a sample.

FIG. 9 illustrates an example system for performing one or more of the functions described herein.

FIG. 10 illustrates example temperature profiles and thermal gradients of SMER (left), water bath (middle), and natural air convection (right) in accordance with a first experimental example.

FIGS. 11A and 11B illustrate tissues that were tested in the first experimental example. FIG. 11A shows the viability of post-thawed vein measured by alamarBlue. FIG. 11B illustrates histological images of hematoxylin and eosin (H&E) stained samples.

FIGS. 12A and 12B illustrate maximum responses (forces) of post-thawed vein rings to the different concentrations of agonist and antagonist. FIG. 12A illustrates the contractile response. FIG. 12B illustrates the relaxation response.

FIG. 13 is a plot illustrating the dielectric loss of samples over various temperatures.

FIGS. 14A to 14C illustrate example results of rewarming Jurkat cell suspensions with different cryoprotective agent compositions.

FIG. 15 illustrates experimental results for different warming system control scenarios in the tracked temperatures over time.

FIG. 16 illustrates temperature profiles and thermal gradients using the different warning techniques.

FIG. 17 illustrates the viability of the post-thawed jugular vein samples.

FIG. 18 illustrates histological images of hematoxylin and eosin (H&E) stained biomaterial tissue samples of this example.

FIG. 19 lists the tissue area percentages obtained for different types of rewarming techniques assessed in this example.

FIG. 20 illustrates the maximal contractile tension of post-thawed vein rings under different concentrations of histamine.

FIG. 21 illustrates the maximal contractile tension of the vein rings with histamine at 10⁻¹ M.

FIG. 22 illustrates the maximal tension relaxation of post-thawed vein rings under different concentrations of sodium nitroprusside.

FIG. 23 illustrates maximal tension relaxation of the vein rings with sodium nitroprusside at 10⁻¹ M.

FIG. 24 illustrates the normalized mitochondrial membrane potential of different samples in an example.

### DETAILED DESCRIPTION

Various implementations described herein relate to techniques for rapid and uniform warming of samples using single-mode electromagnetic (EM) heating. In particular examples, technologies described herein can be used to rewarm cryopreserved biomaterials, such as human organs.

Traditional microwave ovens utilize multimode EM field heating. Although multimode EM field heating can be rapid, it can create multiple hotspots throughout the target of the heat field. These hotspots prevent uniform heating of large tissues, such as organs. If a tissue or organ were to be heated with multimode EM field heating from a cryopreserved temperature, the hotspot would create thermal stresses between cold and hot regions of the tissue where the differences would be great enough to fracture tissue or cause damage to the organ. In contrast, various implementations of the present disclosure utilize single-mode EM heating. Accordingly, implementations can achieve high and uniform EM field intensity to ensure high and uniform warming rates.

Another challenge with EM field heating is the thermal runaway problem. The thermal runaway problem exists due to newly delivered EM thermal energy's propensity to run to regions with the field that ae already at a higher temperature. Hot regions have a higher EM absorptivity, while cooler regions have lower EM absorptivity. This problem can cause non-uniform warming, which can lead to thermal stress and tissue fracture. To address these and other problems, implementations described herein include disposing the sample in a fluid (e.g., a cryoprotective agent or CPA) with relatively high EM absorptivity, which can enable efficient heating of the sample even when the sample is at a relatively low temperature (e.g., when the sample is a cryopreserved tissue). This fluid, for instance, includes magnetic nanoparticles that absorb EM energy and emit heat, which can contribute to sample rewarming.

To achieve single-mode EM heating in a container holding a nonuniform tissue that is in the process of warming, the EM waves generated in the container are adjusted over time. In various implementations, a control system detects a parameter indicating a state of the container as the EM waves are emitted in the container. The control system adjusts the frequency and/or power of the EM waves based on the parameter. Accordingly, single-mode EM heating can be maintained even as the conditions within the container change over time.

In particular examples, a sample loading system is utilized to precisely place the sample at a desired position within the container. The loading system can move the tissue into and out of the container in a limited amount of time and with minimal user intervention.

Implementations of the present disclosure will now be described with reference to the accompanying figures.

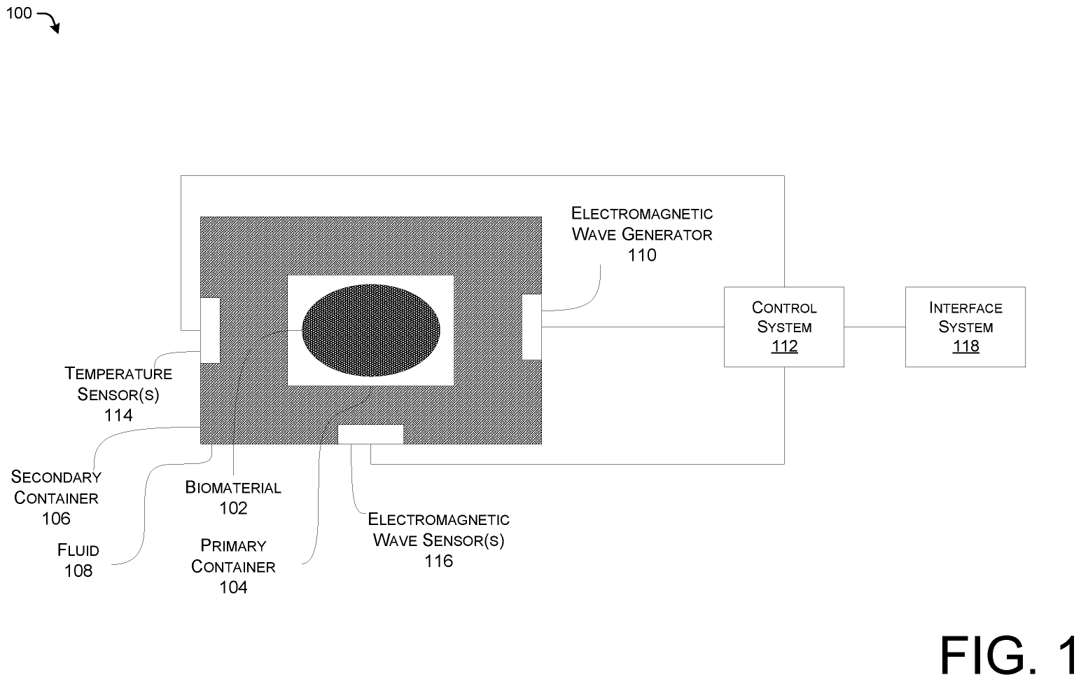

FIG. 1 illustrates an example environment 100 for warming a sample. In various implementations, the sample is a biomaterial 102. As used herein, the term “biomaterial,” and its equivalents, refers to a tissue that includes at least one cell. In some implementations, the biomaterial 102 includes a human tissue. Examples of the biomaterial 102 include a cell suspension, a blood vessel, a seed, an egg, skin, a cornea, a bone, a tendon, a nerve, bone marrow, a portion of an organ (e.g., a heart valve), or an organ. In various cases, at least one dimension of the biomaterial 102 is greater than 1 millimeter (mm), 10 mm, or 100 mm. For example, at least one dimension of the biomaterial 102 is in a range of 5 mm to 30 mm. For instance, the biomaterial 102 may be a preserved human organ, such as a kidney, at least a portion of a liver, a heart, a lung, an ovary, a bladder, a pancreas, a stomach, an intestine, or skin.

According to some examples, the biomaterial 102 is frozen and/or cryopreserved. As used herein, the terms “cryopreserved, “cryoconserved,” and their equivalents, refer to the state of a biological tissue that has been preserved by cooling and maintaining the tissue at a temperature that is low enough to halt or significantly reduce biological and/or chemical reactions within the tissue. For example, a cryopreserved tissue is cooled and/or maintained at a temperature that is below −20° C. In various cases, the biomaterial 102 is at a temperature that is in a range of −100° C. to −20° C.

In some implementations, the biomaterial 102 can be substituted for a non-biomaterial. For instance, a food item may be warmed using the example environment 100. In various cases, the biomaterial 102 and/or other type of sample includes a dielectric material, such as water, silicon oxide, ceramic, a polymer, a metal oxide, or the like. The dielectric material is configured to at least partially absorb EM waves and emit heat.

The biomaterial 102 is disposed inside of a primary container 104. In various implementations, the primary container 104 includes a material that passes, or is otherwise transparent to, EM waves. For example, the primary container 104 includes glass, a metal, a polymer, or any other material that minimally blocks or absorbs EM waves. In some examples, the primary container 104 may be water-tight, such that the primary container 104 may hold a fluid material.

The primary container 104 is disposed inside of a secondary container 106. In various implementations, the secondary container 106 includes a material that reflects EM waves. For instance, at least one interior wall of the secondary container 106 may include a metal (e.g., copper, silver, aluminum, etc.). According to some implementations, air is disposed between an outer wall of the primary container 104 and an inner wall of the secondary container 106.

In various implementations, a fluid 108 is disposed in the primary container 104. The fluid 108 may be configured to pass at least some EM waves and/or absorb at least some EM waves. According to some examples, the fluid 108 is and/or includes a cryopreservation agent (CPA). In some implementations, the fluid 108 includes magnetic nanoparticles. In particular cases, fluid 108 includes water, polyvinylpyrrolidone (PVP), trehalose, dimethyl sulfoxide (DMSO), ethylene glycol, or propylene glycol, or any combination thereof. Although not specifically illustrated in FIG. 1, in some cases, a barrier is disposed between the biomaterial 102 and the fluid 108 within the primary container 104. The barrier, for instance, may prevent the biomaterial 102 from being contaminated by the fluid 108.

An EM wave generator 110 is configured to generate EM waves inside of the secondary container 106. In various cases, the EM waves are in a frequency range of 100 megahertz (MHz) to 1 terahertz (THz). For example, the EM waves are in a range of 100 to 700 MHz. The EM waves, for example, are reflected by at least one interior wall of the secondary container 106. The EM waves may be at least partially absorbed by the biomaterial 102 and the fluid 108. In various implementations, the EM wave generator 110 includes at least one LC circuit. For instance, the EM wave generator 110 includes at least one inductor and/or at least one capacitor that are configured to generate EM waves. In some cases, the EM wave generator 110 includes at least one resistor. For example, the resistor(s) include at least one potentiometer that has changeable resistance. The frequency of EM waves generated by the EM wave generator 110 can be changed by altering the resistance of the potentiometer(s), in some examples.

The biomaterial 102 and the fluid 108 may release heat due to the absorption of the EM waves. In various cases, the EM waves produce alternating electric and magnetic fields within the secondary container 106. Dipolar molecules (e.g., water) within the secondary container 106 rotate to align with the alternating electric fields. Magnetic materials (e.g., ferromagnetic materials) within the secondary container 106 rotate to align with the alternating magnetic fields. Friction is generated by the rotating dipolar molecules and/or magnetic materials, which generates heat. Accordingly, the biomaterial 102 can be rewarmed by the EM waves absorbed by the biomaterial 102 itself and/or the EM waves absorbed by the fluid 108.

In various implementations, the EM wave generator 110 generates single-mode EM field within the secondary container 106. As used herein, the term “single-mode,” and its equivalents, refers to EM waves with a single maximum EM field strength within a defined volume. To generate the single-mode EM field in the reflective secondary container 106, a frequency of the EM waves is dependent on the geometry of the secondary container 106. In some cases, the frequency of the EM waves is dependent on the geometry of the biomaterial 102 and/or the primary container 104. Another factor that can impact the frequency includes the absorption of the biomaterial 102, the primary container 104, and the fluid 108 to the EM waves, which can vary depending on their geometries, materials, and temperatures.

According to various examples, the EM wave generator 110 is communicatively coupled to a control system 112. The control system 112 is configured to output signals to the EM wave generator 110, wherein the EM wave generator 110 adjusts the frequency and/or power of the EM waves based on the signals from the control system 112. In some implementations, the control system 112 includes at least one processor configured to execute various functions. For instance, the processor(s) are configured to execute instructions stored in memory and/or a computer-readable medium.

The control system 112 is communicatively coupled to at least one temperature sensor 114. The temperature sensor(s) 114 are configured to detect at least one temperature within the secondary container 106, such as a temperature of the biomaterial 102, the primary container 104, or the fluid 108. The temperature sensor(s) 114 may be configured to detect the temperature(s) without directly detecting the EM waves transmitted by the EM wave generator 110. For example, the temperature sensor(s) 114 include at least one fiber optic temperature sensor. An example fiber optic temperature sensor includes a temperature-sensitive material (e.g., CdTe, GaAs, Si, or the like) coupled to fiber optic cable, at least one light emitter, and at least one photodetector. An optical characteristic (e.g., absorption, transmissivity, reflectivity, etc.) of the temperature-sensitive material is dependent on its temperature. Accordingly, the temperature of the temperature-sensitive material can be ascertained by transmitting light (e.g., using one or more light-emitting diodes) through the fiber optic cable and detecting the light from the fiber optic cable after the light has encountered (e.g., been reflected, scattered, or transmitted through) the temperature-sensitive material. In some implementations, a Mach-Zehnder interferometric temperature sensor is used as the fiber optic temperature sensor.

The temperature sensor(s) 114, in various cases, transmit a signal indicative of the detected temperature(s) to the control system 112. The signal may be an analog signal that is converted into a digital signal by an analog-to-digital converter (ADC) in the control system 112, or may be a digital signal that is converted from an analog signal by an ADC in the temperature sensor(s) 114.

The control system 112 is communicatively coupled to at least one EM wave sensor 116. In various implementations, the EM wave sensor(s) 116 are configured to detect an electric and/or magnetic field magnitude in the secondary container 116. For example, the EM wave sensor(s) 116 include electric-optic sensor, a piezoelectric-based sensor, an electrostatic-based sensor, a magnetostrictive sensor, or any combination thereof. According to various cases, the EM wave sensor(s) 116 transmits a signal indicative of the electric and/or magnetic field magnitude to the control system 112. The signal, in some cases, is an analog signal that is converted into a digital signal by an ADC in the control system 112, or may be a digital signal that is converted from an analog signal by an ADC in the EM wave sensor(s) 116.

According to some implementations, the EM wave sensor(s) 116 are configured to detect a frequency of the EM waves in the secondary container 116. The control system 112, for example, may receive an analog or digital signal indicating the frequency of the EM waves from the EM wave sensor(s) 116. In various cases, the control system 112 may modify the frequency of the EM waves based on the signal.

The control system 114 may cause the EM wave generator 110 to adjust the frequency and/or magnitude of the EM waves based on the temperature, the electric field magnitude, the magnetic field magnitude, the frequency of the EM waves, or any combination thereof. In particular examples, the control system 114 causes the EM wave generator 110 to produce the EM waves such that the single-mode EM field is maintained within the secondary container 116. In various implementations, the control system 112 causes the EM wave generator 110 to produce EM waves that resonate inside of the interior of the secondary container 106. The temperature detected by the temperature sensor(s) 114, the field strength detected by the EM wave sensor(s) 116, and/or the frequency of the EM waves are indicative of whether the EM waves are resonating within the secondary container 106. Therefore, the control system 112 can adjust the EM waves to achieve a single-mode EM field in the secondary container 106 by controlling the EM wave generator 110 based on the temperature and/or field magnitude.

The environment 100 further includes an interface system 118 that is communicatively coupled to the control system 112. In various implementations, the interface system 118 is configured to receive an input signal from a user and/or to output an output signal to the user. Functions of the interface system 118 may be executed by at least one processor, such as the processor(s) that execute the functions of the control system 112. In addition, the interface system 118 may include one or more output devices, such as a screen, a speaker, or the like.

In some implementations, the interface system 118 is configured to output a status of the interior of the secondary container 106. For example, the interface system 118 may output a current temperature of the biomaterial 102 based on the temperature detected by the temperature sensor(s) 114. In some cases, the control system 112 may determine, based on the temperature detected from the temperature sensor(s) 114, a time until the biomaterial 102 has been rewarmed and the interface system 118 may output the time.

In various implementations, the interface system 118 is configured to receive an input signal from a user. For example, the interface system 118 may output multiple settings for rewarming various types of samples, and the interface system 118 may receive a signal indicating the selection of one of the settings from a user. The setting, for example, may be for rewarming a specific type of organ (e.g., a kidney). The control system 112 may control the EM wave generator 110 based on the selection. For instance, the control system 112 may cause the EM wave generator 110 to output the EM waves at a particular power level or time interval based on the selection. In some implementations, the control system 112 causes the EM wave generator 110 to begin to generate the EM waves based on an input signal from the user.

Various implementations address the thermal runaway problem, among other problems, that cause non-uniform warming of samples. The thermal runaway problem may occur because, as the temperatures of the biomaterial 102 and/or fluid 108 increase, their absorptivity of the EM waves also increases. If unaddressed, the thermal runaway problem may result in undesirable stress on the sample 102 during rewarming. This can be particularly problematic with examples in which the sample 102 is a biological tissue, because the physical stress of uneven warming may result in tissue fracture and cell death.

One way in which the environment addresses the thermal runaway problem is by immersing the biomaterial 102 in the fluid 108. The fluid 108 may include a CPA that has a relatively high dielectric loss over a particular temperature range extending from an initial temperature of the biomaterial 102 and the temperature of the sample 102 after rewarming. The range, for example, includes −70° C. to 0° C. In particular examples, the fluid 108 includes DMSO and PVP. The fluid 108 may absorb energy from the EM waves that would otherwise fuel uneven heating in the biomaterial 102 due to the thermal runaway problem.

In addition, the fluid 108 may include magnetic nanoparticles. While the sample 102 and the material(s) within the fluid 108 with high dielectric loss are configured to absorb energy from the electric field induced by an EM wave, in various cases, they minimally absorb energy from the magnetic field induced by the EM wave. Magnetic nanoparticles in the fluid 108, however, are configured to increase absorption of the magnetic field by the fluid 108. Thus, the magnetic nanoparticles can improve warming of the sample 102 using EM field heating. In particular cases, the magnetic nanoparticles include an iron oxide core with a PEG coating.

In various implementations, the control system 112 tracks and controls resonance of the EM waves within the secondary container 106 over time. Since changes (e.g., temperature changes) in the sample 102 and other components within the secondary container 106 may change the resonant frequency of the environment within the secondary container 106 over time, the control system 112 may cause the EM wave generator 110 to change the frequency of the EM waves over time in order to maintain single-mode EM field heating. Fine control of the resonant frequency can enable more uniform power delivery via the EM waves and therefore more uniform heating of the sample 102. To track and control the resonant frequency, in some examples, impedance matching between the secondary container 106 and EM wave generator 110 is monitored. In various examples, in the resonant state, when the impedance of the secondary container 106 and the EM wave generator 110 is matched, there is rapid and uniform heating of the sample 102.

Although not specifically illustrated in FIG. 1, the environment 100 may further include a loading system configured to precisely and/or rapidly load the sample 102 within the secondary container 106. For example, the loading system may include a linear actuator that extends into the interior of the secondary container 106. In various instances, the linear actuator is configured to move the primary container 104 from the exterior of the secondary container 106 to a position that intersects the geometric center of the secondary container 106, such that the sample 102 is positioned at the center of the secondary container 106 during warming.

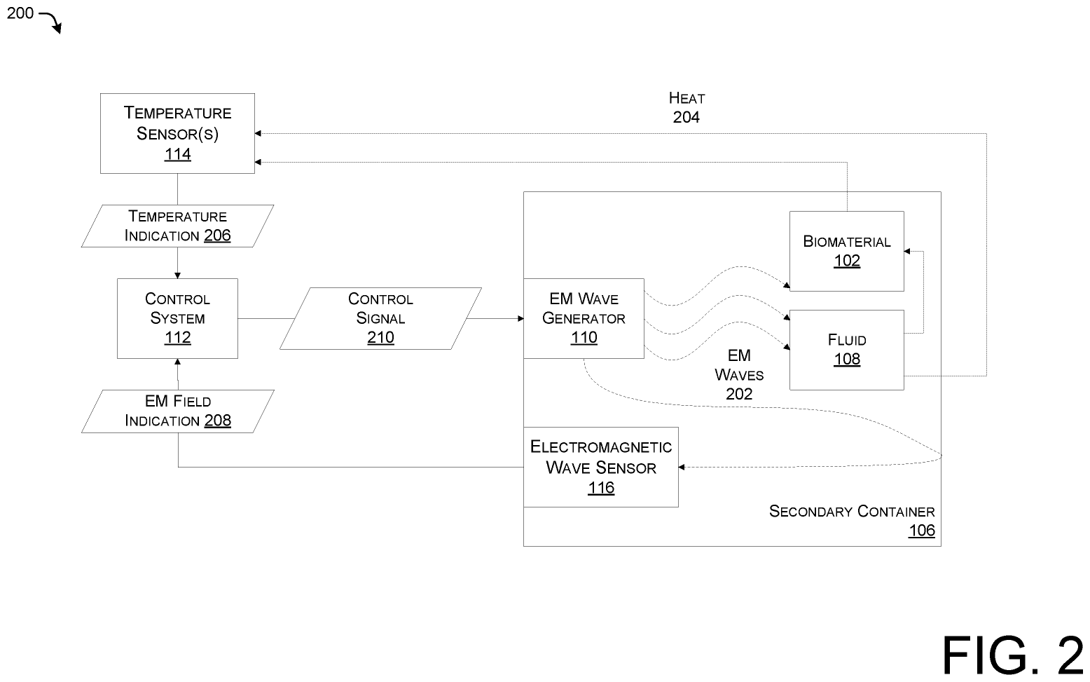

FIG. 2 illustrates example signaling 200 for warming up a sample using single-mode EM field heating. As shown, the signaling 200 is between the biomaterial 102, the secondary container 106, the fluid 108, the EM wave generator 110, the control system 112, the temperature sensor(s) 114, and the EM wave sensor(s) 116 described above with reference to FIG. 1.

In particular cases, the temperature sensor(s) 114 detect a temperature within the secondary container 106 and transmit a temperature indication 202 to the control system 112. For example, the temperature may be of the biomaterial 102, the fluid 108, or some other portion of the secondary container 106. Although the temperature sensor(s) 114 and the EM wave sensor(s) 116 are illustrated outside of the secondary container 106, implementations are not so limited.

The EM wave generator 110 outputs EM waves 202 into the secondary container 106. In some implementations, the EM wave generator 110 includes at least one of a signal generator, a power amplifier, a circulator, a directional coupler, or one or more terminators. At least some of the EM waves 202 are received and absorbed by the biomaterial 102. Some of the EM waves 202 may be received and absorbed by the fluid 108. The biomaterial 202 and/or fluid 108 may output heat 204 based on the absorbed EM waves 202. In some implementations, the fluid 108 outputs heat 204 to the biomaterial 102, and vice versa.

According to some examples, the temperature sensor(s) 114 detects the heat 204 from the biomaterial 102 and/or the fluid 108. The temperature sensor(s) 114 may generate and output a temperature indication 206 based on the heat 204 from the biomaterial 102 and/or the fluid 108. The

In various cases, some of the EM waves 202 may be reflected by the secondary container 106. At least a portion of the reflected EM waves 202 may be absorbed by the biomaterial 102 and/or the fluid 108. In some cases, at least a portion of the reflected EM waves 202 are detected by the EM wave sensor 116. The EM wave sensor 116 generates an EM field indication 208 based on the detected EM waves. The EM field indication 208 may indicate the magnitude (e.g., power) and/or frequency of the EM waves 202 as-detected by the EM wave sensor 116.

In various implementations, the control system 112 may cause the EM wave generator 110 to adjust the EM waves 202 based on the temperature indication 206 and/or the EM field indication 208. In some examples, the control system 112 may determine, based on the temperature indication 206, whether a temperature of the biomaterial 102 is below a threshold temperature. If the temperature is below the threshold, the control system 112 may cause the EM wave generator 110 to output the EM waves 202 at a first power level and/or a first frequency. If the temperature is above the threshold, the control system 112 may cause the EM wave generator 110 to output the EM waves at a second power level and/or a second frequency, wherein the second power level is below the first power level and the second frequency is below the first frequency. In various instances, the control system 112 causes the EM wave generator 110 to decrease the power of the EM waves 202 as the temperature of the biomaterial 102 increases.

In some examples, the control system 112 may cause the EM wave generator 110 to adjust the frequency of the EM waves 202 based on the EM field indication 208. For instance, the control system 112 may determine whether the EM waves 202 are resonating within the secondary container 106 based on the EM field indication 208. In various implementations, the control system 112 may match an impedance of the EM wave generator 110 and the environment within the secondary container 106. In particular examples, the control system 112 causes the EM wave generator 110 to increase or decrease the frequency of the EM waves 202 in response to determining that the EM waves 202 are not resonating in the secondary container 106.

FIG. 3 is a diagram illustrating an example of a single mode EM field. As shown, FIG. 3 illustrates the biomaterial 102, the primary container 104, the secondary container 106, and the fluid 108 described above with reference to FIG. 1. In various implementations, an internal dimension of the secondary container 106 is a, where a is a positive number. For example, a may be in a range of 1 to 100 centimeters (cm).

In various implementations, the biomaterial 102 overlaps a center of the secondary container 106. For example, the biomaterial 102 is aligned with a point that is a/2 from an interior wall of the secondary container 106, along the dimension. In some cases, the biomaterial 102 is loaded at a location overlapping the center of the secondary container 106 by a loading system. The primary container 104, which is disposed around the biomaterial 102, is also at a location that overlaps the center of the secondary container 106.

An EM wave generator (not illustrated) generates EM waves inside of the secondary container 106. The EM waves may be absorbed by the biomaterial 102, the primary container 106, the fluid 108, or any combination thereof. The absorption of the EM waves may increase the temperature of the biomaterial 102. In addition, the EM waves may be reflected from an interior surface of the secondary container 106. The interior surface, for example, includes a metal or some other material that reflects the EM waves.

In FIG. 3, a plot illustrating the electrical field intensity along the dimension of the secondary container 106 is below the illustration of the secondary container 106. As shown, the electrical field intensity peaks at a/2. The electrical field intensity has a single peak along the dimension of the secondary container 106. This electrical field intensity distribution is indicative of single-mode EM heating within the secondary container 106. A multimode distribution, in contrast, would include multiple locations where the EM field is powerful and multiple locations where the EM field is weak. The single mode EM field is more consistent and is more conducive to designing to more uniformly warm a larger tissue sample, such as a cryopreserved organ.

In single-mode, the EM waves resonate within the secondary container 106. That is, the EM waves are maintained as a single standing wave within the secondary container 106. In some implementations, a control system causes the EM waves to resonate by matching the impedance of the EM wave generator to an impedance of the secondary container 106.

Achieving single-mode depends on the length of the dimension of the secondary container 106, the size and shape of the biomaterial 102, and the frequency of the EM waves. Although FIG. 3 is described with respect to a single dimension of the secondary container 106, the lengths of other dimensions are also relevant. In particular examples, for a frequency of 434 MHz, the dimensions of a resonant cavity are 35 cm by 40 cm by 68 cm.

In particular implementations, the frequency of the resonant EM waves can be identified using the following formulations of Maxwell's equations (in Time-Harmonic Form):

$$∇ \times H = j ω ε E + J$$

$$∇ \times E = - j ωμ H$$

$$∇ \cdot ε E = {ρ}_{e}$$

$$∇ \cdot H = 0$$

where, H or \vec{H} is magnetic field, E or \vec{E} is electric field, ω is angular velocity of the EM wave, ε is permittivity of the propagation medium, u is permeability of the propagation medium, J is electric current density, and ρₑ is electric charge density.

In addition, the heat contribution can be represented by the following equation:

$$q = π f {ε}^{″} {\vert E \vert}^{2}$$

where q is specific heat transfer, f is the frequency of EM wave, and ε″ is dielectric loss of the loaded sample.

Further, the energy can be represented by the following equation:

$$ρ C \frac{\partial T}{\partial t} = ∇ \cdot ( k ∇ T ) + q$$

where ρ and C are the density and heat capacity of the loaded sample, f is the frequency of EM wave, ε″ is dielectric loss of the loaded sample, k is thermal conductivity constant. Using the above equations, the frequency of the EM waves for a given container can be derived. In addition, the resonant frequency of the EM waves can be identified by real-time monitoring and adjustment of the frequency and power of the EM waves in the secondary container 106.

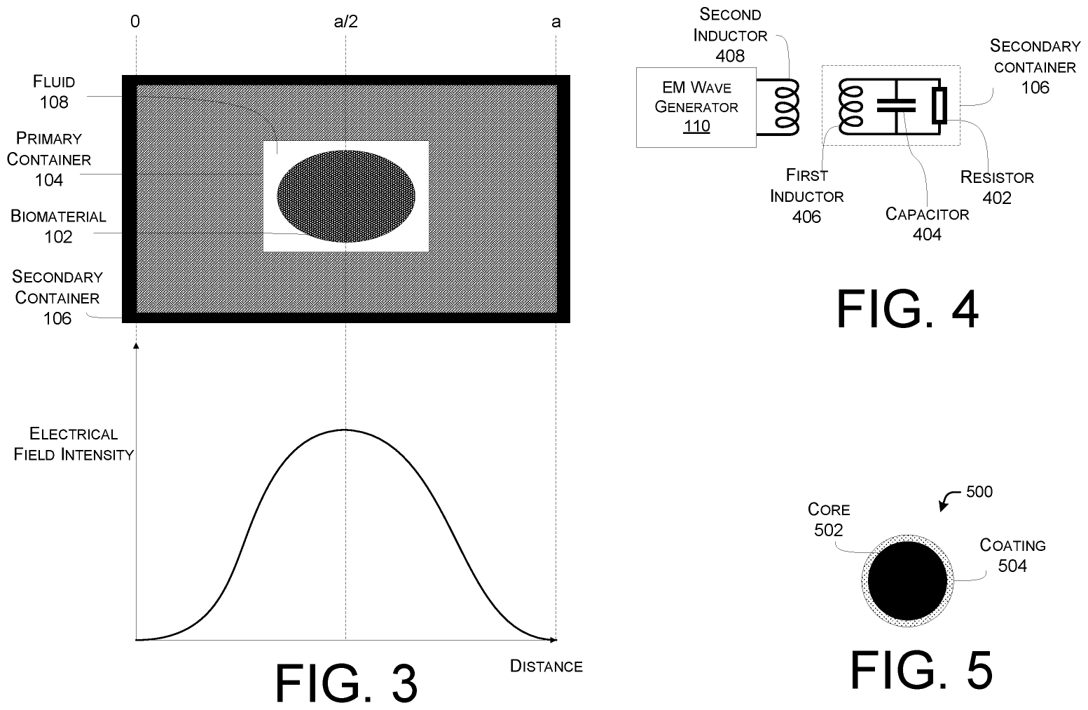

FIG. 4 illustrates a model of a system including the secondary container 106 and the EM wave generator 110. As shown, the secondary container 106 is modeled as a resistor-inductor-capacitor (RLC) circuit. Specifically, the secondary container 106 is modeled as a resistor 402, a capacitor 404, and a first inductor 406. The EM wave generator 110 is modeled as a second inductor 408.

In various implementations, the second inductor 408 emits EM waves. The EM waves are at least partially absorbed by the first inductor 406 of the secondary container 106. The resistance of the resistor 402, the capacitance of the capacitor 404, and the inductance of the first inductor 406 all contribute to the fundamental frequency of the secondary container 106. In various implementations, the EM wave generator 110 matches the frequency of the EM waves emitted by the second inductor 408 to the fundamental frequency of the secondary container 106. For example, the EM wave generator 110 matches its impedance with the impedance of the secondary container 106. Accordingly, the EM waves resonate within the secondary container 106.

FIG. 5 illustrates an example nanoparticle 500 in a fluid used to warm a sample. In various implementations, the fluid is a liquid or a gas. The fluid may include multiple (e.g., numerous) nanoparticles 500.

The nanoparticle 500 includes a core 502 and a coating 504. The core is a magnetic material, in various implementations. Examples of magnetic materials include iron oxide, nickel, and steel. For example, the core 502 includes Fe₃O₄. In some cases, the core 502 includes a material that reacts to the electric field of an EM wave, such as gold, silver, aluminum, or copper. The coating 504 may include a hydrophilic material, such as PEG or some other type of biocompatible coating.

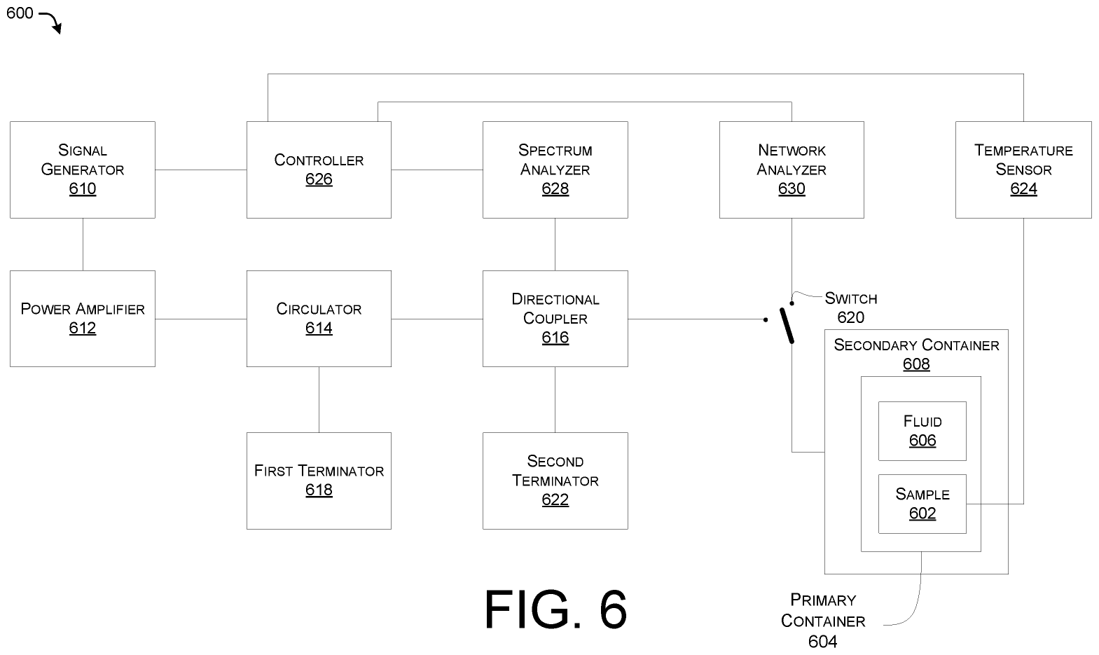

FIG. 6 illustrates a block diagram of an example system 600 for achieving single-mode EM wave heating of a sample 602. As shown, the sample 602 is disposed inside of a primary container 604. The primary container 604, in various implementations, may be transmissible to transmit EM waves. A fluid 606 is also disposed inside of the primary container 604. In various implementations, the fluid 606 includes a cryoprotective agent that is configured to at least partially absorb EM waves. The sample 602, the primary container 604, and the fluid 606 may be disposed inside of a secondary container 608. The secondary container 608, in various implementations, may include a material (e.g., metal) configured to reflect EM waves. Air may be disposed between the interior of the secondary container 608 and the exterior of the primary container 604.

In various implementations, the system 600 is configured to achieve single-mode EM wave heating in the interior of the secondary container 608. The system 600 includes various components configured to generate EM waves within the secondary container 608. For example, the system 600 includes a signal generator 610 configured to generate an electrical signal. The electrical signal, in various implementations, is a periodic signal with a particular frequency. The electrical signal is input into a power amplifier 612. The power amplifier 612 is configured to generate an amplified electrical signal based on the electrical signal generated by the signal generator 610.

A circulator 614 is configured to receive the amplified electrical signal from the power amplifier 612. In various implementations, the circulator 614 is a passive element configured to receive the amplified electrical signal and output a periodic signal. The circulator 614, in some cases, is a ferrite or nonferrite circulator. As illustrated, the circulator 614 includes three ports, one of which is coupled to the power amplifier 612, another which is coupled to a directional coupler 616, and another which is coupled to a first terminator 618. In various cases, the circulator 614 is configured to output the amplified electrical signal to one of the other ports (e.g., to the directional coupler 616 or the first terminator 618). In some cases, the circulator 614 is configured to output a signal from the directional coupler 616 to the first terminator 618, or vice versa.

The directional coupler 616 is configured to output at least a portion of the signal from the circulator 614 to the secondary container 608 as EM waves. A switch 620 is disposed between the directional coupler 616 and the secondary container 608. When the switch 620 is engaged in a first position, the EM waves are emitted into the secondary container 608. When the switch 620 is in a second position, the directional coupler 616 outputs the signal to a second terminator 622. In various implementations, each one of the first terminator 618 and the second terminator 622 is configured to absorb an input signal without reflecting it. For example, the first terminator 618 and/or the second terminator 622 include at least one resistor, at least one diode, or a combination thereof.

The system 600 also includes various elements configured to monitor the EM waves and/or other conditions within the secondary container 608. For example, a temperature sensor 624 is configured to detect a temperature of the sample 602 within the primary container 604. In some implementations, the temperature sensor 624 detects a temperature of the fluid 606 and/or an interior of the secondary container 608, and the temperature of the sample 602 can be approximated based on the temperature of the fluid 606 and/or the interior of the secondary container 608. The temperature sensor 624, for example, is a fiber optic temperature sensor that is configured to detect the temperature without directly detecting the EM waves being transmitted within the secondary container 608. The temperature sensor 624 may input a signal indicative of the temperature into a controller 626. In some cases, the temperature sensor 624 includes at least one ADC, such that the signal output by the temperature sensor 624 is a digital signal.

A spectrum analyzer 628 is coupled to the directional coupler 616. The spectrum analyzer 628 may include a circuit including a sensor configured to detect an electrical signal, an ADC configured to generate a digital signal indicative of the electrical signal, and at least one processor configured to identify a frequency spectrum of the electrical signal by analyzing the digital signal. In particular instances, a Keysight N9320B Spectrum Analyzer by Agilent Technologies of Santa Clara, CA could be used as the spectrum analyzer 628. In various implementations, the directional coupler 616 is configured to provide at least a portion of the signal from the circulator 614 to the spectrum analyzer 628. In various implementations, the spectrum analyzer 628 is configured to detect a frequency of the EM waves output into the secondary container 608 based on a frequency the signal from the directional coupler 616. The spectrum analyzer 628 may output a signal indicative of the frequency of the EM waves into the controller 626. In some cases, the network analyzer 630 includes at least one ADC, such that the signal output by the network analyzer 630 is a digital signal.

A network analyzer 630 is coupled to the switch 620, such that the network analyzer 630 receives a signal indicative of the EM waves in the secondary container 608 when the switch 620 is in the second position. The network analyzer 630 may include a circuit including a sensor configured to detect EM waves and to generate an electrical signal based on the EM waves, an ADC configured to generate a digital signal indicative of the electrical signal, and at least one processor configured to identify a power and/or magnitude of the EM waves based on the digital signal. According to particular instances, an E50618 network analyzer by Agilent Technologies of Santa Clara, CA could be used as the network analyzer 630. In various implementations, the network analyzer 630 is configured to detect a power and/or magnitude of the EM waves based on the signal from the secondary container 608. The network analyzer 630 is further configured to output a signal indicative of the power and/or magnitude of the EM waves to the controller 626. In some cases, the network analyzer 630 includes at least one ADC, and the signal output by the network analyzer 630 is a digital signal.

In various implementations, the controller 626 is configured to adjust the EM waves based on various states of the EM waves and/or the secondary container 608. The controller 626, for example, includes at least one processor. In particular cases, the controller 626 is configured to output one or more control signals to the signal generator 610 that cause the signal generator 610 to set and/or adjust the frequency and/or magnitude of the electrical signal that the signal generator 610 outputs to the power amplifier 612. The controller 626 may generate the control signal(s) based on the signal from the temperature sensor 624, the signal from the spectrum analyzer 628, the signal from the network analyzer 630, or any combination thereof. For instance, the controller 626 causes the signal generator 610 to set and/or adjust the electrical signal based on the frequency of the EM waves, the magnitude and/or power of the EM waves in the secondary container 608, the temperature of the sample 602, or any combination thereof. In various implementations, the control signal(s) generated by the controller 626 cause the system 600 to generate and/or maintain single-mode EM wave heating within the secondary container 608.

Real-time monitoring and controlling of the resonant frequency can be achieved by using a system such as system 600. An electromagnetic subsystem may be defined as including the signal generator 610 and the power amplifier 612. A protection subsystem may be defined as including the circulator 614, the directional coupler 616, the first terminator 618, and the second terminator 622. A container subsystem may be defined as including the primary container 604, the secondary container 608, and a loading system (not pictured). A monitoring subsystem may be defined as including the spectrum analyzer 626, the network analyzer 630, and the temperature sensor 624. A control subsystem may include the controller 626 and is configured to receive output from the monitoring subsystem output and apply frequency changes to the electromagnetic subsystem. Both the circulator 614 and the directional coupler 616 provide some measure of protection to other system components from the increased power of the amplified EM signal. The amplified EM signal is output to the secondary container 608 as EM waves. Not all of the power from the EM waves are absorbed by the components disposed in the secondary container 608, because some of the EM waves reflected within the secondary container 608. The reflected EM waves are measured with the spectrum analyzer 628 and the network analyzer 630 to understand the frequency and power level of the reflected EM waves. Accordingly, the controller 626 may determine how much of the EM waves were absorbed as well as the frequency of the absorbed EM waves within the secondary container 608. Furthermore, by monitoring temperature within the secondary container 608 using the temperature sensor 624, the controller 626 may determine small frequency changes in the EM waves because the frequency of the EM waves is at least partially dependent on the temperature of the components disposed in the secondary container 608. The power and frequency of the EM waves, as well as the temperature of the components in the secondary container 608, cause the controller 626 to make appropriate adjustments to the frequency of the signal generated by the signal generator 610 in order to maintain steady, rapid, and uniform heating of the sample 602.

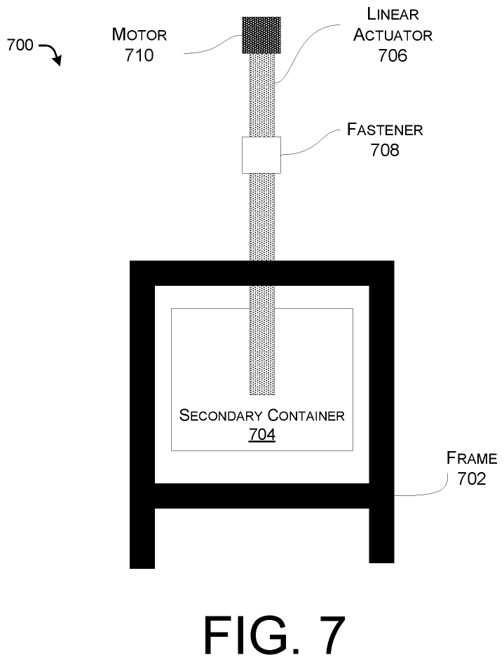

FIG. 7 illustrates an example loading system 700 for EM-based rewarming. The loading system 700 includes a frame 702 that is disposed around a secondary container 704. The frame 702, for example, includes aluminum. The frame 702 may be configured to remain stationary relative to the secondary container 704.

The frame 702 is physically coupled to a linear actuator 706. The linear actuator 706 extends into an interior of the secondary container 704. In various implementations, a fastener 708 (e.g., a clamp) is physically coupled to the linear actuator 708. The linear actuator 706, in various implementations, intersects a geometric center of the secondary container 704. A motor 710 (e.g., a step motor) is configured to move the fastener 708 relative to the secondary container 704 along the linear actuator 706.

In various implementations, a sample is attached to the fastener 708 and the loading system 700 is used to place the sample at the center of the secondary container 704. In some cases, the sample is disposed in a primary container that is attached to the fastener 708. The motor 710 moves the sample along the linear actuator 706 until the sample is disposed at the center point of the secondary container 704. For example, the sample is attached to the fastener 708 while the fastener 708 is disposed outside of the secondary container 704, and is moved into the secondary container 704 via the linear actuator 706. In various implementations, a processor controls the loading system 700. The processor may identify the size of the sample (e.g., based on a user input). The processor may cause the linear actuator 706 and motor to move the sample to a position along the linear actuator 706, wherein the position is based on the size of the sample. Accordingly, the position of the sample may be adjusted by the processor such that the sample overlaps the center of the secondary container 704, regardless of its size.

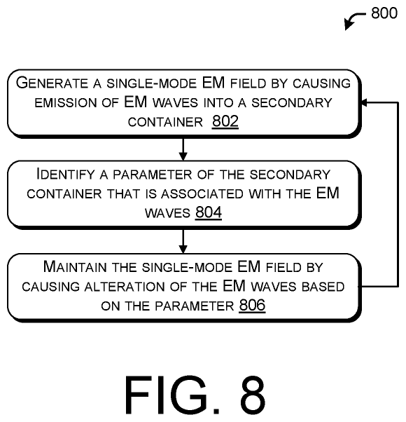

FIG. 8 illustrates an example process 800 for single-mode EM wave heating of a sample. The process 800 may be performed by an entity including at least one of an EM wave generator (e.g., the EM wave generator 110), a control system (e.g., the control system 112), an EM wave sensor (e.g., the EM wave sensor 116), a system (e.g., the system 600), a controller (e.g., the controller 626), one or more processors, or a computing system.

At 802, the entity generates a single-mode EM field by causing emission of EM waves into a secondary container. The secondary container may include a material configured to reflect the EM waves. For example, the metal container includes a metal (e.g., copper). In various implementations, the secondary container has a cylindrical, spherical, or cubic shape.

In various implementations, a primary container is disposed in the secondary container. The primary container may include a material configured to pass the EM waves. For instance, the primary container includes glass.

A sample may be disposed inside of the primary container. In some implementations, the sample is cryopreserved. For example, the sample is at a temperature of −200° C., −180° C., −160° C., −140° C., −120° C., −100° C., −80° C., −60° C., −40° C., or −20° C. In various implementations, the temperature of the sample is in a range of −200 to 0° C.

In some cases, a fluid is also disposed in the primary container. The fluid may be or include a cryoprotective agent. In some cases, the fluid includes at least one of trehalose, PVP, DMSO, ethylene glycol, or propylene glycol, such as a combination of DMSO and PVP. In some cases, the fluid further includes magnetic nanoparticles. An example magnetic nanoparticle may include an iron oxide core and an amphiphilic coating. The amphiphilic coating may be an amphiphilic polymer, such as PEG. In some implementations, the core has a diameter of 9-12 nm.

The EM waves may be at least partially absorbed by the sample and the fluid. In addition, the EM waves may be at least partially reflected by the primary container. In various cases, the EM waves have a frequency of 400 to 500 MHz. The EM waves may be resonant with an interior dimension of the secondary container. Accordingly, the EM waves form a single-mode EM field within the secondary container.

At 804, the entity identifies a parameter of the secondary container that is associated with the EM waves. In various implementations, a temperature sensor detects a temperature within the secondary container, such as the temperature of the sample. The temperature sensor may be an optical fiber sensor. The temperature detected by the temperature sensor is an example of the parameter of the secondary container.

Other examples of the parameter include the power and frequency of the EM waves themselves. For example, a network analyzer may detect the power of the EM waves, which may be reflected inside of the secondary container. In some cases, a spectrum analyzer detects the frequency of the EM waves within the secondary container. According to some examples, a sensor may detect a power and/or frequency of an electrical signal used to generate the EM waves.

At 806, the entity alters the EM waves based on the parameter to maintain the single-mode EM field. In some implementations, the entity increases the frequency of the EM waves based on the parameter. For example, the entity may increase the frequency based on determining that the temperature is below a threshold. The entity may increase the power of the EM waves based on the parameter. For instance, the entity may increase the power based on determining that the temperature is below a threshold.

According to some implementations, the entity performs impedance matching in order to maintain the single-mode EM field. For example, the entity may cause the frequency and/or power of the EM waves to be changed based on a change in a detected impedance of the secondary container.

In various implementations, the process 800 may be repeated to maintain the single-mode EM field for an extended period of time. In some cases, the entity may cause the EM waves to stop based on determining that the temperature of the sample has reached a threshold (e.g., 0° C.).

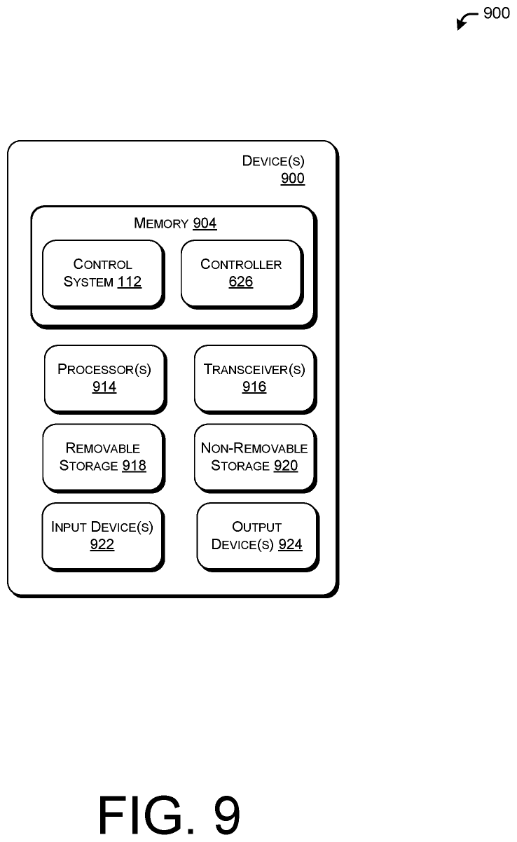

FIG. 9 illustrates at least one example device 900 configured to enable and/or perform the some or all of the functionality discussed herein. Further, the device(s) 900 can be implemented as one or more server computers, a network element on a dedicated hardware, as a software instance running on a dedicated hardware, or as a virtualized function instantiated on an appropriate platform, such as a cloud infrastructure, and the like. It is to be understood in the context of this disclosure that the device(s) 900 can be implemented as a single device or as a plurality of devices with components and data distributed among them.

As illustrated, the device(s) 900 comprise a memory 904. In various embodiments, the memory 904 is volatile (including a component such as Random Access Memory (RAM)), non-volatile (including a component such as Read Only Memory (ROM), flash memory, etc.) or some combination of the two.

The memory 904 may include various components, such as the control system 112, the controller 626, and the like. The control system 112 and/or the controller 626 can include methods, threads, processes, applications, or any other sort of executable instructions. The control system 112 and/or controller 626, as well as various other elements stored in the memory 904 can also include files and databases.

The memory 904 may include various instructions (e.g., instructions in the control system 112 and/or controller 626), which can be executed by at least one processor 914 to perform operations. In some embodiments, the processor(s) 914 includes a Central Processing Unit (CPU), a Graphics Processing Unit (GPU), or both CPU and GPU, or other processing unit or component known in the art.

The device(s) 900 can also include additional data storage devices (removable and/or non-removable) such as, for example, magnetic disks, optical disks, or tape. Such additional storage is illustrated in FIG. 9 by removable storage 918 and non-removable storage 920. Tangible computer-readable media can include volatile and nonvolatile, removable and non-removable media implemented in any method or technology for storage of information, such as computer readable instructions, data structures, program modules, or other data. The memory 904, removable storage 918, and non-removable storage 920 are all examples of computer-readable storage media. Computer-readable storage media include, but are not limited to, RAM, ROM, EEPROM, flash memory or other memory technology, CD-ROM, Digital Versatile Discs (DVDs), Content-Addressable Memory (CAM), or other optical storage, magnetic cassettes, magnetic tape, magnetic disk storage or other magnetic storage devices, or any other medium which can be used to store the desired information and which can be accessed by the device(s) 900. Any such tangible computer-readable media can be part of the device(s) 900.

The device(s) 900 also can include input device(s) 922, such as a keypad, a cursor control, a touch-sensitive display, voice input device, etc., and output device(s) 924 such as a display, speakers, printers, etc. These devices are well known in the art and need not be discussed at length here. In particular implementations, a user can provide input to the device(s) 500 via a user interface associated with the input device(s) 922 and/or the output device(s) 924.

As illustrated in FIG. 9, the device(s) 900 can also include one or more wired or wireless transceiver(s) 916. For example, the transceiver(s) 916 can include a Network Interface Card (NIC), a network adapter, a LAN adapter, or a physical, virtual, or logical address to connect to the various base stations or networks contemplated herein, for example, or the various user devices and servers. To increase throughput when exchanging wireless data, the transceiver(s) 916 can utilize Multiple-Input/Multiple-Output (MIMO) technology. The transceiver(s) 916 can include any sort of wireless transceivers capable of engaging in wireless, Radio Frequency (RF) communication. The transceiver(s) 916 can also include other wireless modems, such as a modem for engaging in Wi-Fi, WiMAX, Bluetooth, or infrared communication.

In some implementations, the transceiver(s) 916 can be used to communicate between various functions, components, modules, or the like, that are comprised in the device(s) 900. For instance, the transceivers 916 may facilitate communications between different elements of the control system 112 and/or controller 626.

### EXPERIMENTAL EXAMPLES

### First Example

In this study, a novel single-mode electromagnetic (EM) resonance (SMER) system was developed, which successfully convers EM energy into rapid-uniform volumetric heating. A dynamic feedback control loop was embedded to achieve real-time monitoring and adjusting the feeding frequency to maintain the biomaterial's higher absorptivity to the EM power. Thus, the EM cavity associated ‘thermal runaway’ problem, which is the increasing temperature difference within the sample because of the temperature-dependent EM power absorption, was limited and improved during the wanning. Moreover, superparamagnetic nanoparticles (SNPs) were adopted to absorb magnetic field energy to further enhance the energy conversion efficiency.

The SNP-enhanced SMER system achieved ultra-rapid and uniform rewarming for large tissues (>25 mL) to avoid ice recrystallization and tissue fracture. The functionality and viability of the cryopreserved rabbit jugular veins using the SMER were comparable to the fresh-tissue control and over 5 times better than using the conventional 37° C. water bath (a current gold standard warming method in the clinical settings).

### Methods

Tissue Harvesting and Handling. Rabbit jugular veins were procured from adult male New Zealaod rabbits (2-3 kg, N ˜26) and immersed in Krebs-Henseleit buffer immediately, then transferred to the research lab within 1 hour. Tissues were sectioned into vein segments with the following dimensions: inner diameter, 2 to 4 mm, wall thickness, 1 to 2 mm, and length, 20 to 40 mm.

Cooling and Rewarming. After loaded with cryoprotective agent (CPA), tissues with CPA solutions in a sample holder were cooled with liquid nitrogen vapor to −150° C. and stored overnight. Three rewarming methods were applied with different warming rates: (1) natural air convection: the cryopreserved tissues were put on the lab bench at room temperature (21-23° C.); (2) water bath heating: the tissues were quickly transferred to 37° C. water bath with shaking at 60 RPM in an orbital motion; (3) SMER system: tissues were quickly transferred to the EM resonant cavity with a maximum power of 400 W. Temperature sensors were placed at the center and edge of the tissue holder, the heating was terminated when sample temperature reached 0° C.

Viability of tissues. Fresh tissue segments were incubated with growth media plus 10% alamarBlue solution at 37° C. and 5% carbon dioxide for 2 hours. The absorbance readings were determined by a microplate reader at 570 and 600 nm to establish the baseline. The same procedure was repeated to obtain the readings of the warmed tissues.

Biomechanical Assessment of Tissues. Warmed tissues were cut into vein rings in the length of 3-5 mm. Each vein ring was mounted to a high-resolution force transducer in a Falcon tube. After loading the agonist (Histamine) and antagonist (Sodium Nitroprusside), contraction and relaxation response were measured by the transducer.

Tissue cryo-survival data was normalized to fresh tissue controls. Statistical significance is indicated with asterisks: ****P<0.0001. The data are presented as the means with SD.

### Results

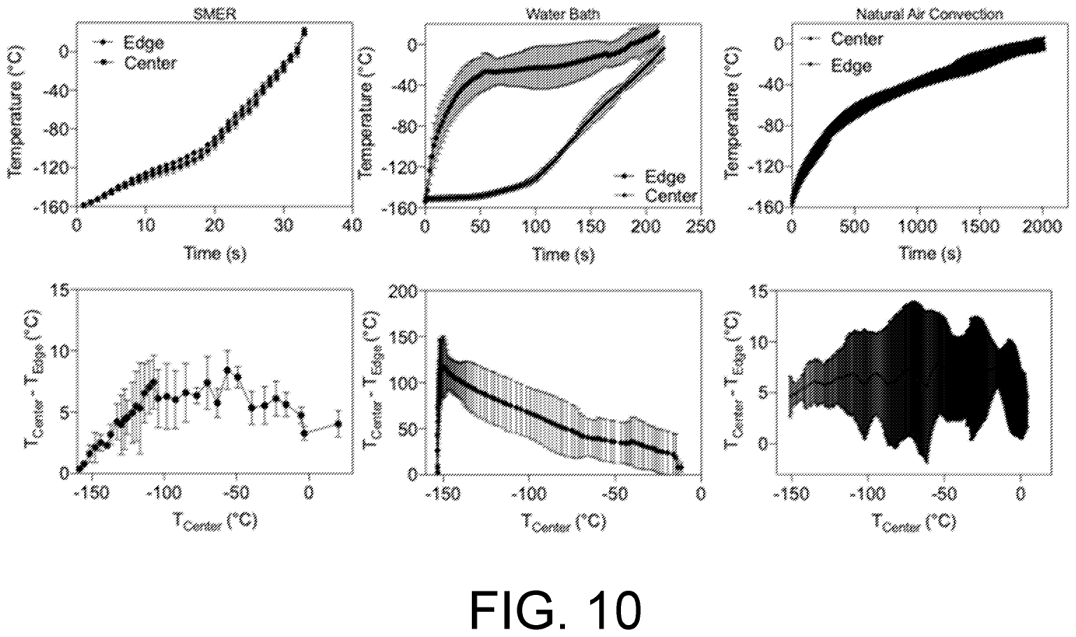

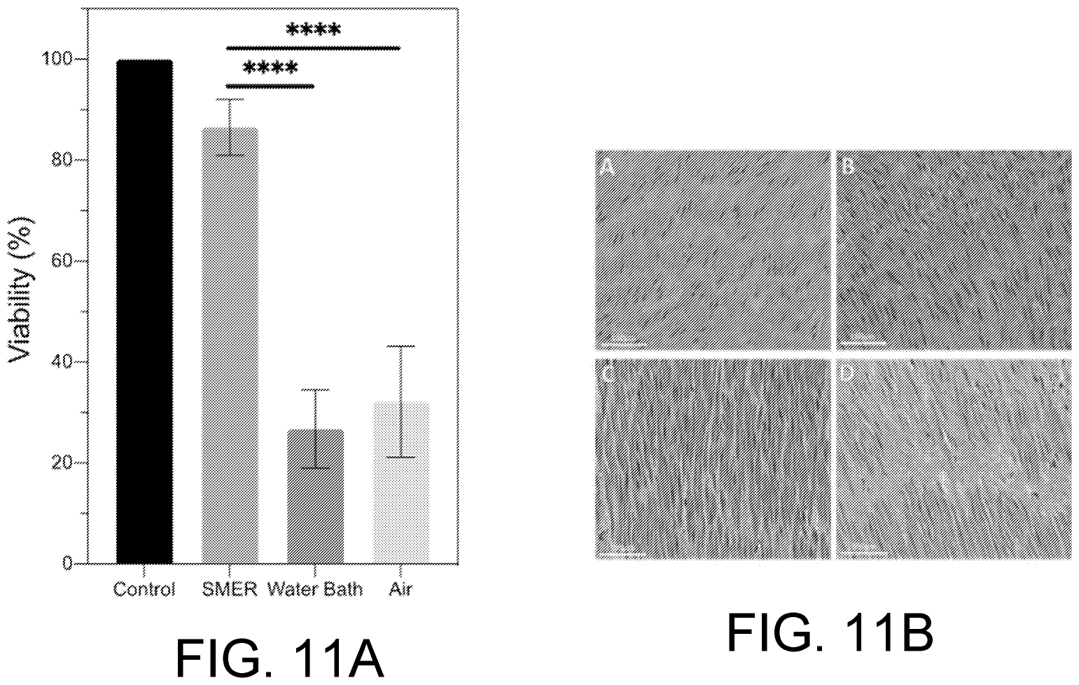

FIG. 10 illustrates example temperature profiles and thermal gradients of SMER (left), water bath (middle), and natural air convection (right). n=9. FIGS. 11A and 11B illustrate tissues that were tested in the first experimental example. FIG. 11A shows the viability of post-thawed vein measured by alamarBlue. FIG. 11B illustrates histological images of hematoxylin and eosin (H&E) stained samples (A, fresh tissue; B, SMER; C, water bath; D, natural air convection).

As shown in FIG. 11A, viability of the vein warmed by SMER showed no statistical difference (P=0.3675) from the fresh samples at 86.54±5.63%, significantly higher than the convective water bath (26.73±7.75%), and air warmed (32.13±11.04%). The large decline of tissue viability in water bath and air warmed indicate the cryo-injuries caused by slow and non-uniform warming. The results were supported by H&E stained histological images. The SMER image (B) demonstrates well-defined intact nuclear morphology.

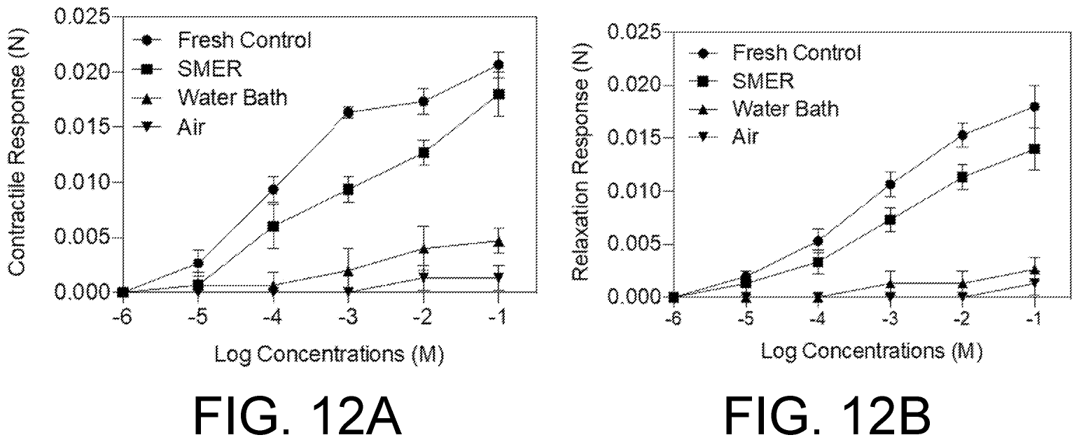

FIGS. 12A and 12B illustrate maximum responses (forces) of post-thawed vein rings to the different concentrations of agonist and antagonist. FIG. 12A illustrates the contractile response. FIG. 12B illustrates the relaxation response.

Recorded temperature profiles and thermal gradient between tissue center and edge of three warming methods are shown in FIG. 10. The water bath heating achieved an average warming rate at 46.52±4.85° C. min⁻¹, with a large temperature difference especially at the beginning of the warming. Natural air heating succeeded in a relatively uniform temperature distribution that confined the temperature difference within 10° C., but a slow rate at 4.53±0.14° C. min⁻¹. SNPs-enhanced SMER system accomplished the uniform warming while surged the heating rate to 326.91±7.55° C. min⁻¹.

### DISCUSSION

In this study, a novel SMER was developed for rapid and uniform rewarming of large biomaterials in cryopreservation. SMER technology were compared with two conventional heating approaches, i.e., water bath heating and room-temperature air heating, respectively, during the cryopreservation of the rabbit jugular veins. Through the systematic examinations of the heating effects on cryopreserved biomaterials, it was found that tissue samples rewarmed with slow and non-uniformed methods showed large decline of the viability and damage to the functionality, presumably due to the cell ruptures and tissue facture caused by the lethal ice-crystallization and large temperature gradient.

On the other hand, rapid and uniform heating achieved by SMER technology provides a promising approach to the rewarming of large volume biomaterials. All the viability test, histological analysis, and biomechanical assessment results confirmed the successful rewarming of tissues by SNPs enhanced SMER system which maintained the tissue viability and functionality nearly identical to the fresh control. Ongoing and future studies include the further applications of the SMER system for cryopreservation of larger organs like human kidney and heart to meet the increased and urgent needs in organ transplantation.

### Second Example

In this example, various CPA solutions were evaluated for efficacy with SMER. The following Table 1 provides the composition of five sample CPA solutions that were evaluated.

| | |
|---|---|
| CPA | Concentration (g/dL) |

| Sample | Combination | D | E | P | PVP |
|---|---|---|---|---|---|
| 1 | D + PVP | 41 | 0 | 0 | 6 |
| 2 | E + PVP | | 44 | 0 | 6 |
| 3 | P + PVP | 0 | 0 | 36 | 6 |
| 4 | D + P + PVP | 20 | 0 | 20 | 6 |
| 5 | E + P + PVP | 0 | 20 | 20 | 6 |

Where D is dimethyl sulfoxide, E is ethylene glycol, P is propylene glycol, an PVP is polyvinylpyrrolidone K30 (Mᵣ=40,000 Da).

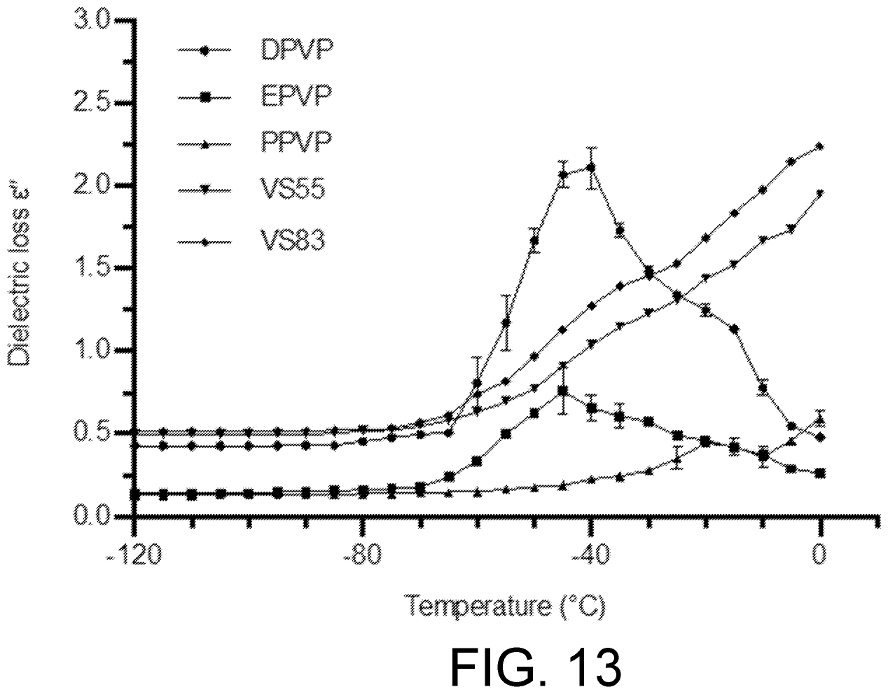

FIG. 13 is a plot illustrating the dielectric loss of the samples listed in Table 1 above over various temperatures. When evaluating for a CPA solution that mitigates the thermal runaway problem, it was determined that certain CPAs and/or combinations of CPAs (such as DMSO-PVP) exhibited a high dielectric loss over the temperature range, which indicates that they are well-suited to prevent runaway of a hot spot in an example biomaterial (e.g., organ) being warmed. Over the temperature range of −70° C. to 0° C., different CPAs exhibited higher dielectric loss, meaning that they had increased absorptivity for EM thermal energy, effectively drawing some energy that might otherwise go to fueling a thermal runaway problem away from the biomaterial and into the more uniform CPA solution.

To further address thermal runaway, and additionally harness the power from the magnetic field generated with EM field energy, magnetic nanoparticles were also introduced to the CPA solutions. While the biomaterials and the CPA react to the energy created from the electric portion of the EM field, which results in heating, the magnetic nanoparticles are configured to react with the magnetic field to produce heat as well, aiding in warming. In particular, iron oxide nanoparticles (with diameters of 10 nm), were added to the CPA solutions. A PEG coating was applied to the nanoparticles to promote uniform distribution in the solution. The magnetic nanoparticles also smooth heat delivery to the biomaterial from the solution, as all is warmed by the EM field.

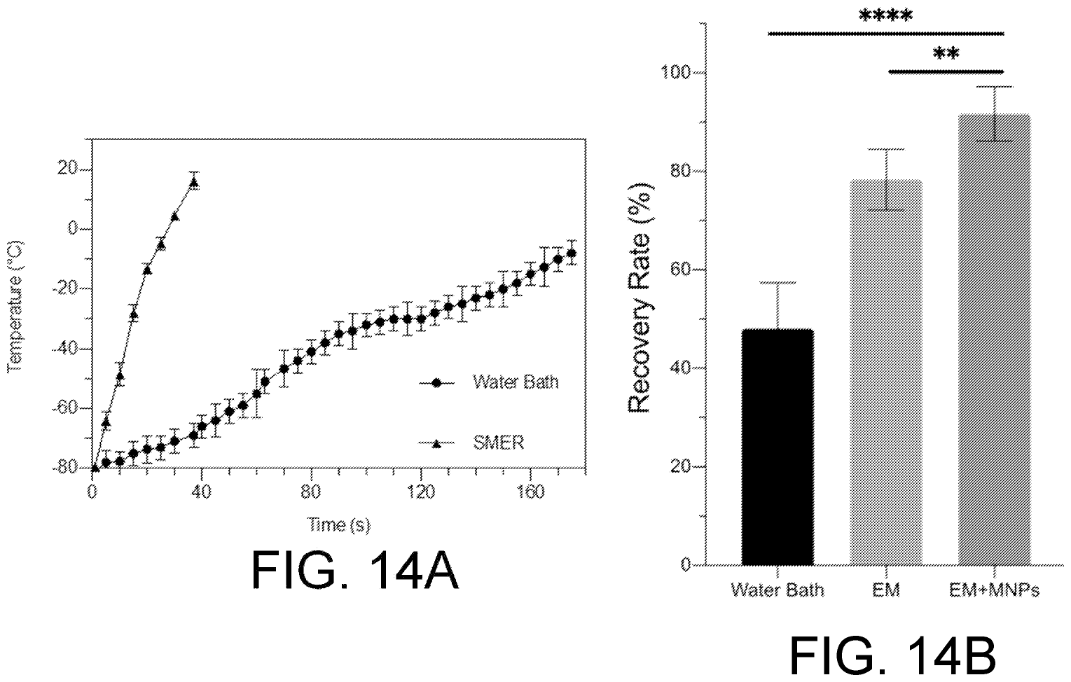

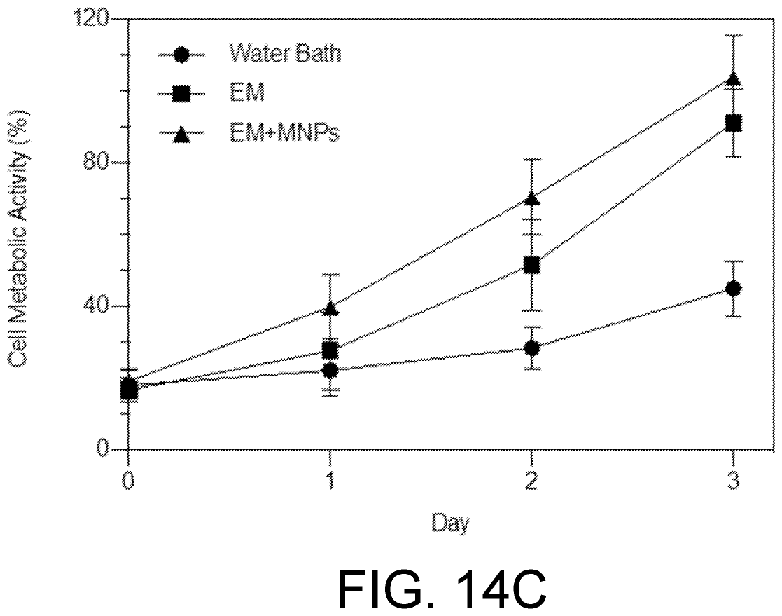

FIGS. 14A to 14C illustrate example results of rewarming Jurkat cell suspensions with different CPA compositions. 25 mL Jurkat cell suspensions were cryopreserved and rewarmed in different CPA solutions. A first CPA solution included 10% DMSO and 0.25 M trehalose. A second CPA solution included 10% DMSO, 0.25 M trehalose, and MNPs at a concentration of 0.1 mg Fe per mL. The cell suspensions were cryopreserved for 24 hours at a cooling rate of 1° C. per minute. The suspensions and CPA (10% DMSO with 0.25 M trehalose) were rewarmed using a water bath and EM-based techniques described herein. FIG. 14A illustrates times at which the cell suspensions were rewarmed using the different techniques and CPA compositions. Table 2 (below) illustrates the average rewarming rate for the different samples.

| Method | Average Warming Rate (° C./minute) |
|---|---|
| Water Bath | 26.7 |
| EM | 91.3 |
| EM + Magnetic Nanoparticles | 152.4 |

FIG. 14B illustrates recovery rates for the cell suspensions after rewarming. Table 3 (below) illustrates the recovery rates of the different samples

| Method | Recovery Rate (n = 12) | P-value |
|---|---|---|
| Water Bath | 48.0 ± 9.3% | <0.0001 |
| EM | 78.3 ± 6.2% | 0.0027 |
| EM + Magnetic Nanoparticles | 91.7 ± 5.5% | |

FIG. 14C illustrates cell metabolic activity of the different samples in days after rewarming. Based on these results, EM single-mode heating with a CPA that includes magnetic nanoparticles can result in a faster warming rate, a greater recovery rate of rewarmed cells, and greater metabolic activity of the rewarmed cells after warming.

### Third Example

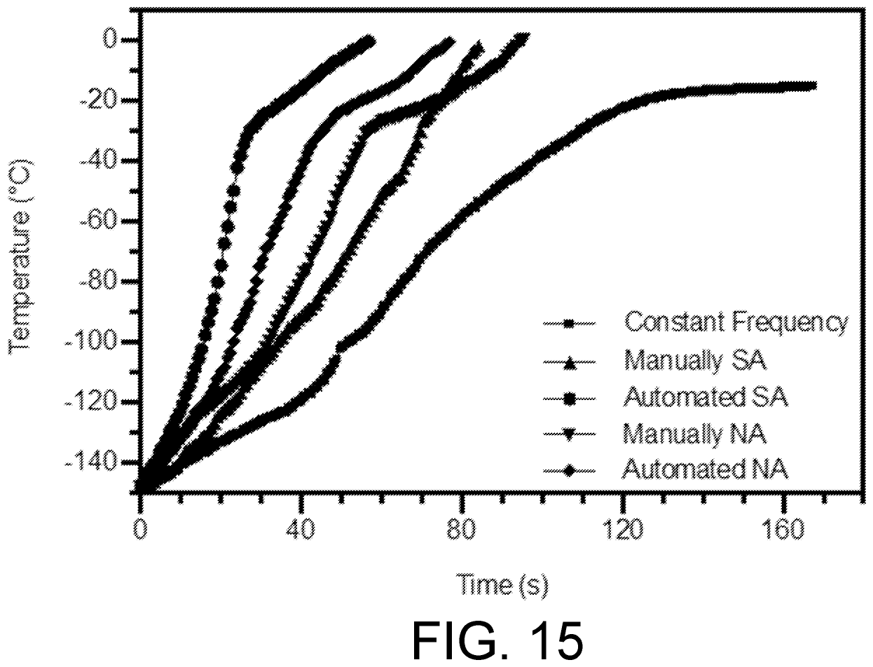

FIG. 15 illustrates experimental results for different warming system control scenarios in the tracked temperatures over time. This example utilized a CPA that included 41% DMSO, 6% PVP, and 10% glycerol. The curve to the far right represents warming using a constant frequency without adjusting for system feedback—this version did not achieve 0° C. (the temperature at which warming is stopped) after more than 160 seconds and plateaued around −20° C., meaning the impedance wasn't matched and the EM field was not efficiently supplying power to warm the targets. The constant frequency meant that the control system was bypassed, such that there were no adjustments to the EM wave frequency during operation. The curve on the far left is an automated system control using a spectrum analyzer input primarily to drive changes in the EM signal frequency. The spectrum analyzer measured and monitored the reflected EM waves in terms of power and frequency from the secondary container. The spectrum analyzer output a signal to the control system based on the power and frequency of the reflected EM waves. The control system caused the EM wave generator to adjust the power and frequency of the EM waves based on the signal from the spectrum analyzer.

### Fourth Example

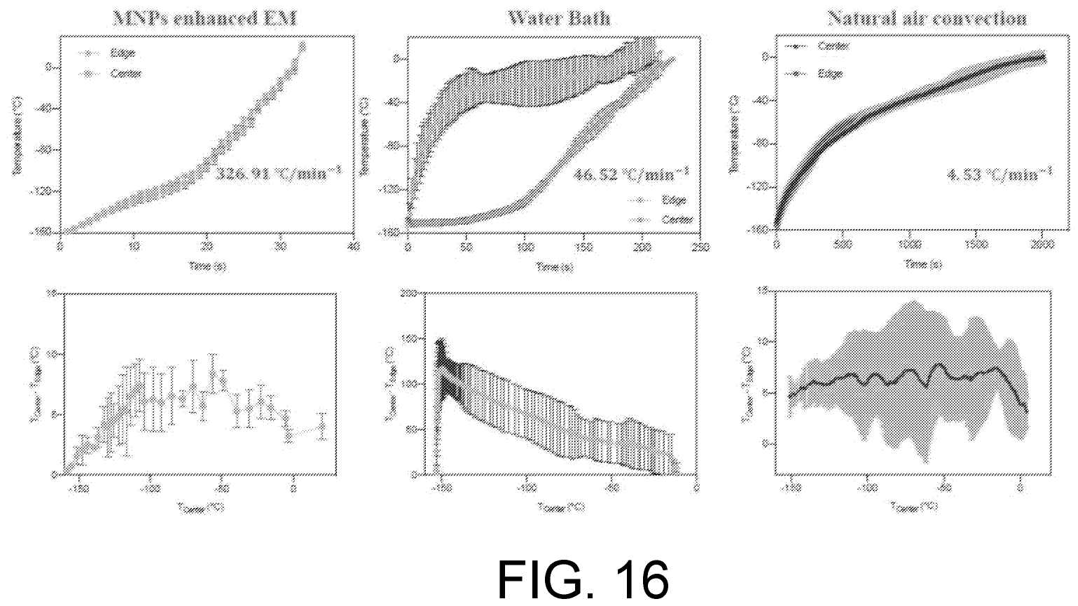

In this experimental example, 25 mL rabbit jugular veins were cryopreserved for 24 hours in a CPA that included 41% DMSO and 6% PVP. The CPA further include magnetic nanoparticles at a concentration of 0.1 mg Fe mL⁻¹. The rabbit jugular veins were cooled at a rate of 5° C. per minute. Multiple rewarming methods were assessed, including a water bath, natural air convection, and single-mode EM wave heating. FIG. 16 illustrates temperature profiles and thermal gradients using the different warning techniques.

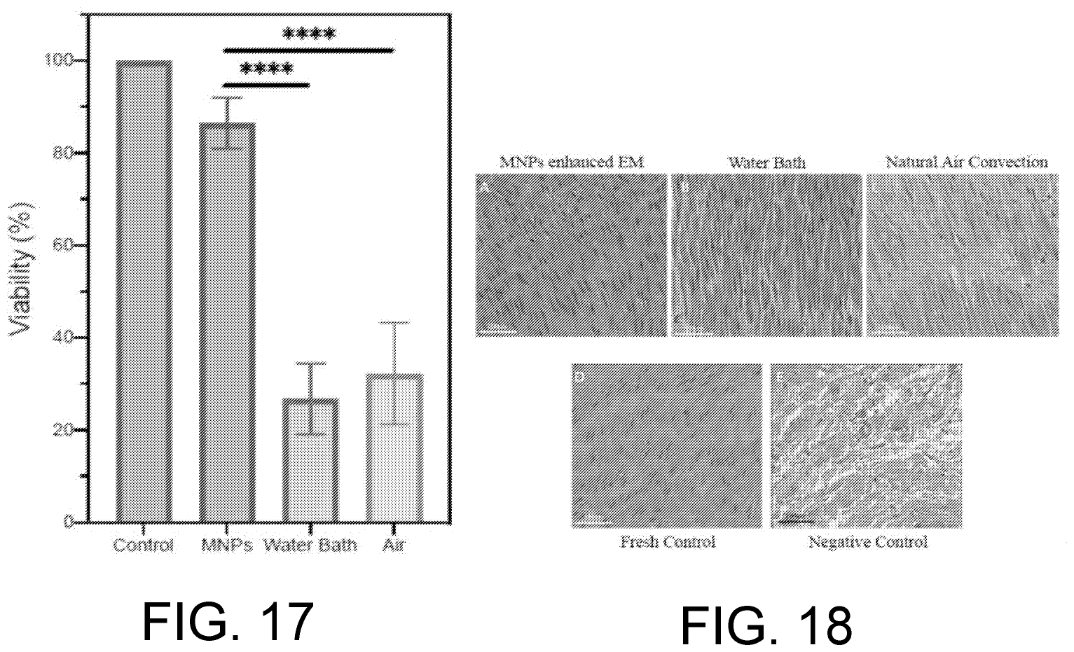

FIG. 17 illustrates the viability of the post-thawed jugular vein samples. Viability was determined by alamarBlue assay. After rewarming, post-thawed veins were sectioned into vein rings with lengths in a range of 3-5 mm. The rings were coupled to a force sensor. Histamine was utilized as an agonist to induce contraction in the rings. Sodium nitroprusside was used as an antagonist to induce relaxation in the rings. The viability was calculated by comparing readings before and after cooling and rewarming were assessed. In addition, data was normalized to the fresh control group including rabbit jugular veins that were not cryopreserved or rewarmed (defined as 100% viability). Table 4 (below) also summarizes the viability of tissues rewarmed using the different techniques assessed in this example.

| Rewarming Method | Viability (n = 9) |
|---|---|
| Water Bath | 26.7 ± 7.8% |
| Air | 32.1 ± 11.0% |
| EM Single-Mode with Magnetic Nanoparticles | 86.54 ± 5.6% |

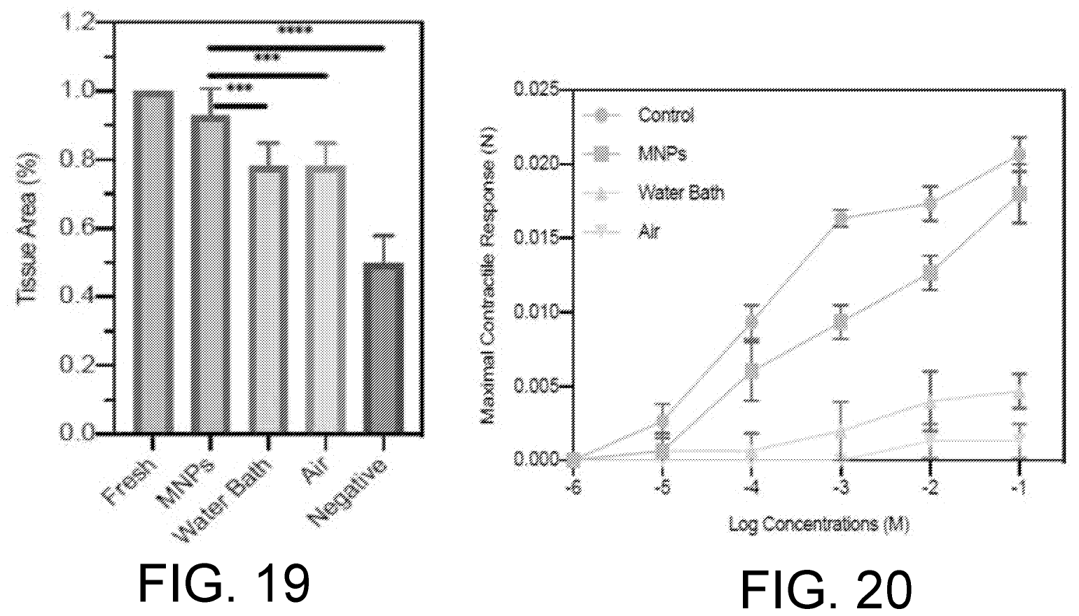

FIG. 18 illustrates histological images of hematoxylin and eosin (H&E) stained biomaterial tissue samples of this example. Hematoxylin stains cell nuclei and eosin stains extracellular matrix and cytoplasm. The area percentage of the H&E stained tissues in these images were also assessed. The stained area of an image of a fresh sample (that was not cryopreserved or rewarmed) was normalized to 100%. As shown in FIG. 18, the tissues rewarmed using a CPA with magnetic nanoparticles exhibited a larger tissue area percentage than tissues rewarmed using a water bath or natural air convection. FIG. 19 lists the tissue area percentages obtained for different types of rewarming techniques assessed in this example. Table 5 (below) also summarizes the tissue area percentages.

| | Method | | | |
|---|---|---|---|---|
| | EM Warming | | | |
| | with Magnetic | Water | Air | Negative |
| | Nanoparticles | Bath | Convection | Control |
| Tissue Area | 93.0 ± 7.7% | 78.2 ± 6.7% | 71.1 ± 8.7% | 49.9 ± 7.9% |

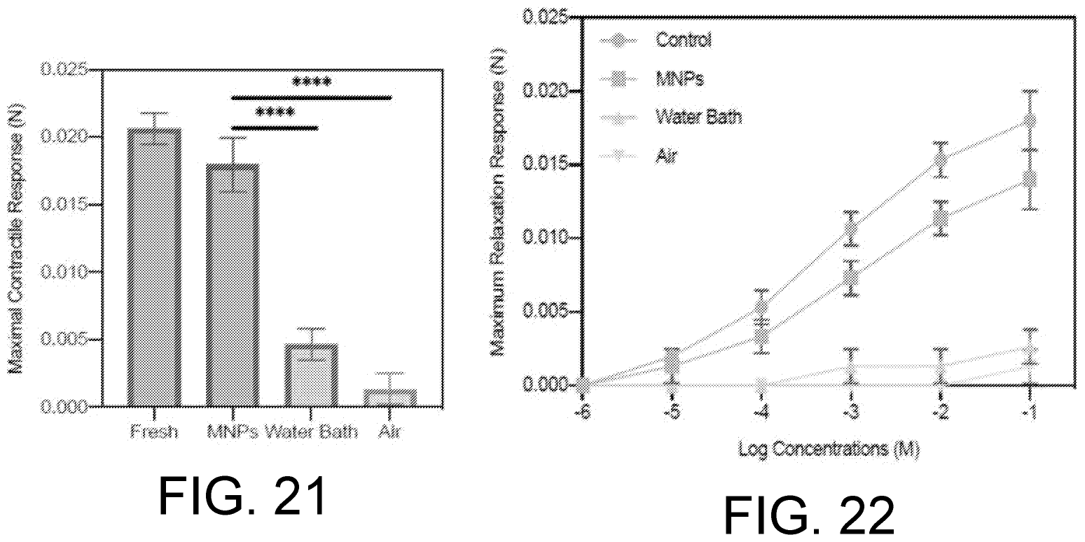

FIG. 20 illustrates the maximal contractile tension of post-thawed vein rings under different concentrations of histamine. FIG. 21 illustrates the maximal contractile tension of the vein rings with histamine at 10⁻¹ M. As shown, the tissue samples subjected to EM rewarming with the CPA including magnetic nanoparticles exhibited significantly higher maximal contractile response than the samples rewarmed using a water bath or air convection.

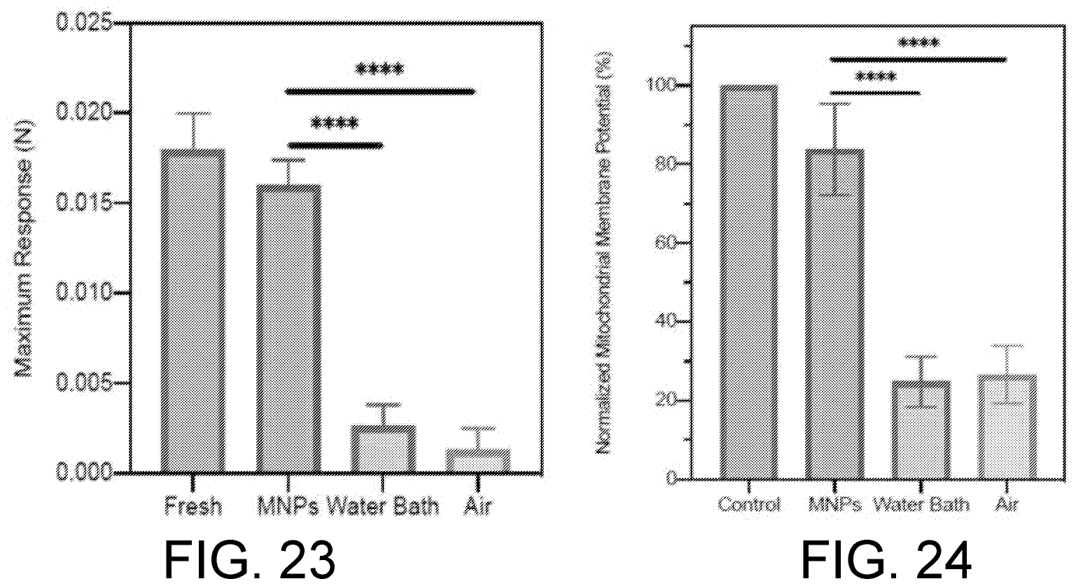

FIG. 22 illustrates the maximal tension relaxation of post-thawed vein rings under different concentrations of sodium nitroprusside. FIG. 23 illustrates maximal tension relaxation of the vein rings with sodium nitroprusside at 10⁻¹ M. The tissue samples subjected to EM rewarming with the CPA including magnetic nanoparticles exhibited significantly higher maximum tension relaxation than the samples rewarmed using a water bath or air convection.

FIG. 24 illustrates the normalized mitochondrial membrane potential of different samples this example. The mitochondrial membrane potential was determined by tetramethylrhodamine, methyl ester (TMRM) assay. Fluorescence readings were obtained at 548 nm. Relative fluorescent units (RFU) were normalized to the fresh issue control group and represented in percentage. Table 6 (below) also summarizes the mitochondrial membrane potential of the different samples assessed in this example (n=9).

| | Mitochondrial Membrane |
|---|---|
| Method | Potential (n = 9) |
| Water Bath | 24.8 ± 6.3% |
| Air Convection | 26.2 ± 11.6% |
| EM Warming With Magnetic Nanoparticles | 83.7 ± 11.6% |

### Example Clauses

1. A single-mode electromagnetic field rewarming system, the system including: a primary container configured to enclose a biomaterial; a secondary container configured to enclose the primary container; a cryoprotective agent disposed between a wall of the primary container and the biomaterial, the cryoprotective agent including magnetic nanoparticles; an electromagnetic wave generator configured to generate a single-mode electromagnetic field in the secondary container by outputting electromagnetic waves into the secondary container; a temperature sensor configured to detect a temperature of the biomaterial; an electromagnetic wave sensor configured to detect a power and a frequency of the electromagnetic waves in the secondary container that are reflected from the wall of the secondary container; and a processor that is communicatively coupled to the electromagnetic wave generator, the temperature sensor, and the electromagnetic wave sensor, the processor being configured to control the electromagnetic waves output by the electromagnetic wave generator based on the temperature and the power and the frequency of the electromagnetic waves.
2. The system of clause 1, wherein the primary container includes glass.
3. The system of clause 1 or 2, wherein the wall of the secondary container includes a metal.
4. The system of clause 3, wherein the interior wall of the secondary container includes a cylinder, a sphere, or a cubic shape.
5. The system of any one of clauses 1 to 4, wherein the cryoprotective agent further includes at least one of trehalose, polyvinylpyrrolidone (PVP), dimethyl sulfoxide (DMSO), ethylene glycol, or propylene glycol.
6. The system of any one of clauses 1 to 5, wherein the magnetic nanoparticles include: an iron oxide core with a diameter of 5 to 25 nanometers (nm); and an amphiphilic polymer disposed on a surface of the iron oxide core.
7. The system of any one of clauses 1 to 6, wherein the electromagnetic waves have a frequency of 415 to 445 MHz.
8. The system of any one of clauses 1 to 7, wherein a first dimension of the secondary container is 30 to 40 centimeters (cm), a second dimension of the secondary container is 35 to 45 cm, and a third dimension of the secondary container is 65 to 80 cm.
9. The system of any one of clauses 1 to 8, wherein a frequency of the electromagnetic waves is resonant with an interior dimension of the secondary container.
10. The system of any one of clauses 1 to 9, wherein the temperature sensor includes an optical fiber sensor.
11. The system of any one of clauses 1 to 10, the processor being a first processor, wherein the electromagnetic wave sensor includes: an electrical sensor configured to detect a signal indicative of the EM waves; an analog to digital converter (ADC) configured to convert the signal indicative of the EM waves into a digital signal; and a second processor configured to determine the power and the frequency of the EM waves by analyzing the digital signal.
12. The system of any one of clauses 1 to 11, wherein the processor is configured to cause the electromagnetic wave generator to output the electromagnetic waves at a first power and/or first frequency in response to the temperature being at a first level and to output the electromagnetic waves at a second power and/or second frequency in response to the temperature being at a second level, the first power being greater than the second power, the first frequency being greater than the second frequency, and the first level being lower than the second level.
13. The system of any one of clauses 1 to 12, wherein the processor is configured to control the electromagnetic waves output by the electromagnetic wave generator based on the temperature, the power, and the frequency of the electromagnetic waves by: determining an impedance of the secondary container; and causing an impedance of the electromagnetic wave generator to match the impedance of the secondary container.
14. The system of any one of clauses 1 to 13, further including: a loading system including a linear actuator configured to move the primary container into the secondary container.
15. The system of any one of clauses 1 to 14, wherein the biomaterial is warmed by the electromagnetic waves from a temperature that is in a range of −20 to −196 degrees Celsius.
16. A device, including: a container configured to enclose a sample; a fluid disposed in the container, the fluid including magnetic nanoparticles; an electromagnetic field generator configured to generate a single-mode electromagnetic field in the container by outputting electromagnetic waves into the container; a sensor configured to detect a parameter indicative of the container; and a processor configured to control the electromagnetic field generator based on the parameter.
17. The device of clause 16, wherein an interior wall of the container is configured to reflect the electromagnetic waves.
18. The device of clause 16 or 17, the container being a secondary container and enclosing a primary container configured to enclose the sample, the primary container being at least partially pass the electromagnetic waves.
19. The device of any one of clauses 16 to 18, wherein the interior wall of the container includes a cylinder, a sphere, or a cubic shape.
20 The device of any one of clauses 16 to 19, wherein the fluid further includes at least one of polyvinylpyrrolidone (PVP), trehalose, dimethyl sulfoxide (DMSO), ethylene glycol, or propylene glycol.
21. The device of any one of clauses 16 to 20, wherein the magnetic nanoparticles include: an iron oxide core with a diameter of 8 to 12 nanometers (nm); and an amphiphilic polymer disposed on a surface of the iron oxide core.
22. The device of any one of clauses 16 to 21, wherein the electromagnetic waves have a frequency of 400 to 500 MHz.
23. The device of any one of clauses 16 to 22, wherein a frequency of the electromagnetic waves is dependent on a dimension of the container.
24. The device of any one of clauses 16 to 23, wherein the sensor includes a temperature sensor and the parameter includes a temperature inside of the container.
25. The device of clause 24, wherein the processor is configured to cause the electromagnetic wave generator to output the electromagnetic waves at a first power and/or first frequency in response to the temperature being at a first level and to output the electromagnetic waves at a second power and/or second frequency in response to the temperature being at a second level, the first power being greater than the second power and the first level being lower than the second level.
26. The device of any one of clauses 16 to 25, wherein the sensor includes an electromagnetic power sensor and the power includes an electromagnetic power inside of the container.
27. The device of any one of clauses 16 to 26, wherein the processor is configured to control the electromagnetic field generator based on the parameter by: identifying, based on the parameter, an impedance of the container; and adjusting an impedance of the electromagnetic field generator to be within a range of the impedance of the container.
28. The device of any one of clauses 16 to 27, wherein the processor is configured to control the electromagnetic field generator based on the parameter by: identifying a change in the parameter; and based on identifying the change in the parameter, causing the electromagnetic field generator to adjust a frequency of the electromagnetic waves to maintain resonance between the electromagnetic waves and the container.
29. The device of any one of clauses 16 to 28, further including:
a loading system configured to transport the sample in and out of the container.
30. The device of clause 29, wherein the loading system includes an actuator configured to move the sample into the container.
31. A method for rewarming a cryopreserved material, the method including: identifying a parameter indicating a state of a container enclosing a single-mode electromagnetic field; and maintaining the single-mode electromagnetic field by adjusting, based on the parameter, a frequency and/or a power of the electromagnetic waves.
32. The method of clause 31, wherein identifying the parameter includes detecting a temperature in the container.
33. The method of clause 32, wherein adjusting, based on the parameter, the frequency and/or the power of the electromagnetic waves includes: determining that the temperature is increasing; and based on determining that the temperature is increasing, decreasing the power of the electromagnetic waves.
34. The method of any one of clauses 31 to 33, wherein identifying the parameter includes detecting the power of the electromagnetic waves.
35. The method of any one of clauses 31 to 34, wherein adjusting, based on the parameter, the frequency and/or the power of the electromagnetic waves includes: identifying, based on the parameter, an impedance of the container; and adjusting an impedance of an electromagnetic field generator generating the electromagnetic waves to be within a range of the impedance of the container.
36. The method of any one of clauses 31 to 35, wherein adjusting, based on the parameter, the frequency and/or the power of the electromagnetic waves includes: identifying a change in the parameter; and based on the change in the parameter, adjusting a frequency of the electromagnetic waves to maintain resonance between the electromagnetic waves and the container.
37. A device including: at least one processor; and memory storing instructions that, when executed by the at least one processor, cause the at least one processor to perform operations including the method of any one of clauses 31 to 36.
38. A nontransitory computer-readable medium storing instructions that, when executed by the at least one processor, cause the at least one processor to perform operations including the method of any one of clauses 31 to 36.
39. A cryoprotective agent for rewarming cryopreserved tissues, the cryoprotective agent including: a dielectric fluid including at least one of polyvinylpyrrolidone (PVP), trehalose, dimethyl sulfoxide (DMSO), ethylene glycol, or propylene glycol; and magnetic nanoparticles.
40. The cryoprotective agent of clause 39, wherein the dielectric fluid includes PVP and DMSO.
41. The cryoprotective agent of clause 39 or 40, wherein an example magnetic nanoparticle among the magnetic nanoparticles includes: an iron oxide core with a diameter of 10 nanometers; and a PEG coating disposed on the iron oxide core.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be used for realizing implementations of the disclosure in diverse forms thereof.

As will be understood by one of ordinary skill in the art, each implementation disclosed herein can comprise, consist essentially of or consist of its particular stated element, step, or component. Thus, the terms “include” or “including” should be interpreted to recite: “comprise, consist of, or consist essentially of.” The transition term “comprise” or “comprises” means has, but is not limited to, and allows for the inclusion of unspecified elements, steps, ingredients, or components, even in major amounts. The transitional phrase “consisting of” excludes any element, step, ingredient or component not specified. The transition phrase “consisting essentially of” limits the scope of the implementation to the specified elements, steps, ingredients or components and to those that do not materially affect the implementation. As used herein, the term “based on” is equivalent to “based at least partly on,” unless otherwise specified.

Unless otherwise indicated, all numbers expressing quantities, properties, conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e. denoting somewhat more or somewhat less than the stated value or range, to within a range of ±20% of the stated value; ±19% of the stated value; ±18% of the stated value; ±17% of the stated value; ±16% of the stated value; ±15% of the stated value; ±14% of the stated value; ±13% of the stated value; ±12% of the stated value; ±11% of the stated value; ±10% of the stated value; ±9% of the stated value; ±8% of the stated value; ±7% of the stated value; ±6% of the stated value; ±5% of the stated value; ±4% of the stated value; ±3% of the stated value; ±2% of the stated value; or ±1% of the stated value.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing implementations (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate implementations of the disclosure and does not pose a limitation on the scope of the disclosure. No language in the specification should be construed as indicating any non-claimed element essential to the practice of implementations of the disclosure.

Groupings of alternative elements or implementations disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain implementations are described herein, including the best mode known to the inventors for carrying out implementations of the disclosure. Of course, variations on these described implementations will become apparent to those of ordinary skill in the art upon reading the foregoing description. The inventors expect skilled artisans to employ such variations as appropriate, and the inventors intend for implementations to be practiced otherwise than specifically described herein. Accordingly, the scope of this disclosure includes all modifications and equivalents of the subject matter recited in the claims appended hereto as permitted by applicable law. Moreover, any combination of the above-described elements in all possible variations thereof is encompassed by implementations of the disclosure unless otherwise indicated herein or otherwise clearly contradicted by context.

1. A single-mode electromagnetic field rewarming system, the system comprising:
a primary container configured to enclose a biomaterial;
a secondary container configured to enclose the primary container;
a cryoprotective agent disposed between a wall of the primary container and the biomaterial, the cryoprotective agent comprising magnetic nanoparticles;
an electromagnetic wave generator configured to generate a single-mode electromagnetic field in the secondary container by outputting electromagnetic waves into the secondary container;
a temperature sensor configured to detect a temperature of the biomaterial;
an electromagnetic wave sensor configured to detect a power and a frequency of the electromagnetic waves in the secondary container that are reflected from the wall of the secondary container; and
a processor that is communicatively coupled to the electromagnetic wave generator, the temperature sensor, and the electromagnetic wave sensor, the processor being configured to control the electromagnetic waves output by the electromagnetic wave generator based on the temperature and the power and the frequency of the electromagnetic waves.

2-5. (canceled)

6. The system of claim 1, wherein the magnetic nanoparticles comprise:
an iron oxide core with a diameter of 5 to 25 nanometers (nm); and
an amphiphilic polymer disposed on a surface of the iron oxide core.

7. The system of claim 1, wherein the electromagnetic waves have a frequency of 415 to 445 MHz.

8. (canceled)

9. The system of claim 1, wherein a frequency of the electromagnetic waves is resonant with an interior dimension of the secondary container.

10. (canceled)

11. The system of claim 1, the processor being a first processor, wherein the electromagnetic wave sensor comprises:
an electrical sensor configured to detect a signal indicative of the electromagnetic waves;
an analog to digital converter (ADC) configured to convert the signal indicative of the EM waves into a digital signal; and
a second processor configured to determine the power and the frequency of the electromagnetic waves by analyzing the digital signal.

12-14. (canceled)

15. The system of claim 1, wherein the biomaterial is warmed by the electromagnetic waves from a temperature that is in a range of −20 to −196 degrees Celsius.

16. A device, comprising:
a container configured to enclose a sample, an interior wall of the container being configured to reflect electromagnetic waves;
a fluid disposed in the container, the fluid comprising magnetic nanoparticles;
an electromagnetic field generator configured to generate a single-mode electromagnetic field in the container by outputting the electromagnetic waves into the container;
a sensor configured to detect a parameter indicative of the container; and
a processor configured to control the electromagnetic field generator based on the parameter.

17-18. (canceled)

19. The device of claim 16, wherein the interior wall of the container comprises a cylinder, a sphere, or a cubic shape.

20. The device of claim 16, wherein the fluid further comprises at least one of polyvinylpyrrolidone (PVP), trehalose, dimethyl sulfoxide (DMSO), ethylene glycol, or propylene glycol.

21. The device of claim 16, wherein the magnetic nanoparticles comprise:
an iron oxide core with a diameter of 8 to 12 nanometers (nm); and
an amphiphilic polymer disposed on a surface of the iron oxide core.

22. The device of claim 16, wherein the electromagnetic waves have a frequency of 400 to 500 MHz.

23. (canceled)

24. The device of claim 16, wherein the sensor comprises a temperature sensor and the parameter comprises a temperature inside of the container, and
wherein the processor is configured to cause the electromagnetic wave generator to output the electromagnetic waves at a first power and/or first frequency in response to the temperature being at a first level and to output the electromagnetic waves at a second power and/or second frequency in response to the temperature being at a second level, the first power being greater than the second power and the first level being lower than the second level.

25. (canceled)

26. The device of claim 16, wherein the sensor comprises an electromagnetic power sensor and the power comprises an electromagnetic power inside of the container.

27. The device of claim 16, wherein the processor is configured to control the electromagnetic field generator based on the parameter by:
identifying, based on the parameter, an impedance of the container; and
adjusting an impedance of the electromagnetic field generator to be within a range of the impedance of the container.

28. The device of claim 16, wherein the processor is configured to control the electromagnetic field generator based on the parameter by:
identifying a change in the parameter; and
based on identifying the change in the parameter, causing the electromagnetic field generator to adjust a frequency of the electromagnetic waves to maintain resonance between the electromagnetic waves and the container.

29. The device of claim 16, further comprising:
a loading system configured to transport the sample in and out of the container,
wherein the loading system comprises an actuator configured to move the sample into the container.

30. (canceled)

31. A method for rewarming a cryopreserved material, the method comprising:
identifying, by detecting a power of electromagnetic waves in a container enclosing a single-mode electromagnetic field, at least one parameter indicating a state of the container; and
maintaining the single-mode electromagnetic field by adjusting, based on the at least one parameter, a frequency of the electromagnetic waves and/or the power of the electromagnetic waves.

32. The method of claim 31, wherein identifying the at least one parameter comprises detecting a temperature in the container, and
wherein adjusting, based on the at least one parameter, the frequency of the electromagnetic waves and/or the power of the electromagnetic waves comprises:
determining that the temperature is increasing; and
based on determining that the temperature is increasing, decreasing the power of the electromagnetic waves.

33-34. (canceled)

35. The method of claim 31, wherein adjusting, based on the at least one parameter, the frequency of the electromagnetic waves and/or the power of the electromagnetic waves comprises:
identifying, based on the at least one parameter, an impedance of the container; and
adjusting an impedance of an electromagnetic field generator generating the electromagnetic waves to be within a range of the impedance of the container.

36. The method of claim 31, wherein adjusting, based on the at least one parameter, the frequency and/or the power of the electromagnetic waves comprises:
identifying a change in the at least one parameter; and
based on the change in the at least one parameter, adjusting a frequency of the electromagnetic waves to maintain resonance between the electromagnetic waves and the container.

37-41. (canceled)
